(19) United States
(12) Patent Application Publication
(10) Pub. No.: US 2011/0054921 A1
(43) Pub. Date: Mar. 3, 2011

(54) SYSTEM FOR PLANNING THE PLANTING AND GROWING OF PLANTS

(76) Inventor: Heather LYNDS, Lawrence, KS (US)

(21) Appl. No.: 12/849,149

(22) Filed: Aug. 3, 2010

Related U.S. Application Data
(60) Provisional application No. 61/272,163, filed on Aug. 25, 2009.

(51) Int. Cl. G06Q 10/00

(52) U.S. Cl. 705/1.1

(57) ABSTRACT

A method for generating a plan facilitating users to plant, grow, harvest and maintain selected plant varieties includes receiving, via at least one processor, user input corresponding to at least one of: the selected plant varieties, desired servings of the selected plant varieties, geographic information for the user and available gardening hardware. The method includes determining, via the at least one processor, quantities of the selected plant varieties to plant, a location layout for planting each of the selected plant varieties and plant care tasks associated with each of the selected plant varieties. The method also includes graphically presenting, via the at least one processor, the location layout and the plant care tasks associated with each of the selected plant varieties to the user.

### CLAIM OF PRIORITY

This application is a non-provisional application of pending U.S. Provisional Patent Application 61/272,163, filed on Aug. 25, 2009, the disclosure of which is expressly incorporated herein by reference in its entirety.

### BACKGROUND

1. Field of the Disclosure

The present disclosure relates to generating garden plans. More particularly, the present disclosure relates to a system and method for facilitating the planning, planting, growing and maintaining of plants in a garden, for a number of plant varieties.

2. Background Information

Gardeners gardening plants in gardens typically rely on years of experience in determining varieties of plants to plant, quantities of plants to plant, locations at which to plant and time periods during which to sow seeds, transplant seedlings, and harvest fruits, vegetables and herbs. However, amateur gardeners are typically unaware of optimal timeframes for planting seeds and transplanting seedlings when considering germination, growth and harvest temperature requirements for each plant variety. Amateur gardeners are typically unaware as to how to extend a harvest throughout a growing season by planting successive plantings of various plant varieties. Further, amateur gardeners may be unaware of important techniques for protecting the health of a garden, including planting methods in which plant varieties of the same plant family are not planted in the same location during consecutive harvest seasons (i.e., in order to prevent pest infestation and disease), and planting methods in which plant varieties are optimally placed to take advantage of positive co-planting plant varieties and reduce adverse impacts of negative co-planting plant varieties. Moreover, gardeners may be unaware as to a number of plants to plant in order to obtain a desired harvest quantity.

In view of the above, gardeners are not able to optimize gardening variables while accounting for fixed gardening values. That is, gardeners are unable to produce an optimal harvest by selecting planting quantities, planting dates and planting locations, while constrained by climate, garden size and garden hardware and plant varieties. Additionally, gardeners are unable to make real-time recalculations and updates to a garden plan, and efficiently maintain records of plantings from season to season that may be necessary to optimize the garden plan.

Even if gardeners rely on their experience in planting plants and determining when to harvest plants and how much to harvest, gardeners may forget when to harvest a plant variety and where to plant the plant variety in a subsequent harvest season.

### SUMMARY OF THE INVENTION

According to an aspect of the present disclosure, a method for generating a plan facilitating users to plant, grow, harvest and maintain selected plant varieties, includes receiving, via at least one processor, user input corresponding to at least one of: the selected plant varieties, desired servings of the selected plant varieties, geographic information for the user and available gardening hardware. The method includes determining, via the at least one processor, quantities of the selected plant varieties to plant, a location layout for planting each of the selected plant varieties and plant care tasks associated with each of the selected plant varieties. The method also includes graphically presenting, via the at least one processor, the location layout and the plant care tasks associated with each of the selected plant varieties to the user.

According to another aspect of the present disclosure, the geographic information includes at least one of: a postal code, a latitude, a longitude and a mailing address.

According to yet another aspect of the present disclosure, the method includes retrieving frost dates based on the geographic information.

According to still another aspect of the present disclosure, the quantities of the selected plant varieties account for an estimated loss percentage.

According to an aspect of the present disclosure, the estimated loss percentage is estimated based on weather, loss due to pests and loss due to plant disease.

According to another aspect of the present disclosure, the method includes displaying a plurality of plant varieties to the user, from which the selected plant varieties are chosen, the plurality of plant varieties being chosen based on the geographic information and a current date.

According to yet another aspect of the present disclosure, the method includes calculating a frequency for succession plantings over a current harvest period.

According to still another aspect of the present disclosure, the method includes obtaining information related to whether the user is willing to transplant plants from indoor to outdoor.

According to an aspect of the present disclosure, the layout is based at least one of: a determination of which plant varieties to plant proximate to one another, a determination of which plant varieties to plant distant from one another, trellis requirements for each of the selected plant varieties, height of each of the selected plant varieties, water requirements for each of the selected plant varieties and sunlight requirements for each of the selected plant varieties.

According to another aspect of the present disclosure, the method includes presenting the user with an option to purchase additional gardening hardware when gardening hardware requirements for producing the desired servings of the selected plant varieties exceed the available gardening hardware.

According to yet another aspect of the present disclosure, dates for succession plantings and a frequency of succession plantings are based on season window and the season window is based on an earliest planting date, a latest maturity date and a calculated number of available growth days.

According to still another aspect of the present disclosure, the plant care tasks include at least one of: planting seeds outdoors, planting a plant from nursery stock, planting a plant grown from seeds sown indoors, harvesting plants, watering plants and pruning plants.

According to an aspect of the present disclosure, the method includes displaying the plant care tasks according to dates on which the plant care tasks are to be performed.

According to another aspect of the present disclosure, planting dates for planting the selected plant varieties are determined based on: frost hardiness, current harvest season and whether planting from seed, planting from nursery stock or planting from seeds sown indoors.

According to yet another aspect of the present disclosure, the method includes the layout is based on a planting square division of a garden bed.

According to still another aspect of the present disclosure, a representation of a quantity of sunlight and a representation of a quantity of shade is displayed for each planting square of the garden bed.

According to an aspect of the present disclosure, the method includes the user is enabled to at least one of: assign and edit the representation of the quantity of sunlight and the representation of the quantity of shade for each planting square of the garden bed.

According to another aspect of the present disclosure, the method includes modifying the plan when one of the plant care tasks is not performed on a date on which the plant care task is to be performed.

According to yet another aspect of the present disclosure, the planting dates are further based on air temperatures for at least one of: seed germination date and frost dates.

According to still another aspect of the present disclosure, a recommended garden bed size is presented to the user based on the desired servings of the selected plant varieties.

According to an aspect of the present disclosure, plant seed catalogs from a plurality of vendors are supported.

According to another aspect of the present disclosure, the user is enabled to purchase seeds for at least one of the selected plant varieties via a website interface.

According to yet another aspect of the present disclosure, the user is enabled to manually enter a desired plant variety.

According to still another aspect of the present disclosure, the method includes archiving plans for at least one prior harvest season to determine whether crop cycling at a location is to be implemented.

According to an aspect of the present disclosure, a system for generating a plan facilitating users to plant, grow, harvest and maintain selected plant varieties includes a receiver that receives user input corresponding to at least one of: the selected plant varieties, desired servings of the selected plant varieties, geographic information for the user and available gardening hardware. The system includes a determiner that determines quantities of the selected plant varieties to plant, a location layout for planting each of the selected plant varieties and plant care tasks associated with each of the selected plant varieties. The system includes a presenter that graphically presents the location layout and the plant care tasks associated with each of the selected plant varieties to the user.

According to another aspect of the present disclosure, a non-transitory, tangible computer readable medium for generating a plan facilitating users to plant, grow, harvest and maintain selected plant varieties includes a receiving code segment, recorded on the tangible computer readable medium, that receives user input corresponding to at least one of: the selected plant varieties, desired servings of the selected plant varieties, geographic information for the user and available gardening hardware. The computer readable medium includes a determining code segment, recorded on the tangible computer readable medium, that determines quantities of the selected plant varieties to plant, a location layout for planting each of the selected plant varieties and plant care tasks associated with each of the selected plant varieties. The computer readable medium includes a presenting code segment, recorded on the tangible computer readable medium, that graphically presents the location layout and the plant care tasks associated with each of the selected plant varieties to the user.

According to yet another aspect of the present disclosure, a harvest season associated with the plan is defined by either a time period of increasing temperature that excludes short-term directional changes in temperature or a time period of decreasing temperature that excludes short-term directional changes in temperature.

According to still another aspect of the present disclosure, the user is enabled to manually edit a supported plant variety.

According to an aspect of the present disclosure, the location layout is based on an orientation of a garden bed associated with the plan.

According to another aspect of the present disclosure, the orientation of the garden bed is specified by the user based on at least one of: graphically presented directional arrows and a geographic reference, and the geographic reference comprises at least one of: a north, south, east, west, sunrise and sunset direction.

According to yet another aspect of the present disclosure, the presenting code segment further presents harvest instructions for each of the selected plant varieties.

According to still another aspect of the present disclosure, the harvest instructions are based on a harvest interval for each of the selected plant varieties.

According to an aspect of the present disclosure, the method the harvest interval specifies a frequency of harvesting.

According to one aspect of the present disclosure, the layout location for each of the selected plant varieties is specified based on at least one planting square in the garden bed.

According to another aspect of the present disclosure, at least one planting square in the garden bed is evaluated to determine the location layout for each of the selected plant varieties.

According to yet another aspect of the present disclosure, the at least one planting square is evaluated based on whether plants planted in the at least one planting square during a predetermined time period are members of a common taxonomy family with at least one of the selected plant varieties.

According to still another aspect of the present disclosure, the at least one planting square is evaluated based on crop rotation.

According to an aspect of the present disclosure, a method for generating a plan facilitating users to plant, grow, harvest and maintain selected plant varieties includes determining, by at least one processor, a level of suitability of a specified planting method for a specified plant variety based on at least one of: whether the specified plant variety is transplantable, whether a user is willing to plant seeds indoors for the specified plant variety and a season window for the specified planting method. The specified planting method comprises at least one of planting seeds indoors, planting nursery stock, planting seeds outdoors.

According to another aspect of the present disclosure, the season window is a range of dates specifying a subset of a harvest season during which conditions are attained such that at least one plant of the specified plant variety grows.

According to yet another aspect of the present disclosure, the season window is adjusted based on at least one of: germination temperature requirements for the specified plant variety, growth temperature requirements for the specified plant variety, frost conditions for a user location and sunlight conditions for the user location.

According to still another aspect of the present disclosure, the season window is adjusted further based on a suitability requirement defined by the user.

According to an aspect of the present disclosure, the suitability requirement specifies at least one of: a time period in the season window and a percentage of the season window during which air temperatures are within a tolerable range for supporting plant growth for the specified plant variety.

According to another aspect of the present disclosure, the method includes determining, by the at least one processor, whether a plant category associated with the specified plant variety is an onion category, determining, by the at least one processor, whether a user location is located between a lower limit latitude and an upper limit latitude when the plant category is the onion category and determining, by the at least one processor, that the specified planting method is not suitable based on the user location.

According to yet another aspect of the present disclosure, the level of suitability of the specified planting method is a binary determination.

According to still another aspect of the present disclosure, the level of suitability of the specified planting method is specifiable as one of at least three levels of suitability.

Other exemplary embodiments and advantages of the present invention may be ascertained by reviewing the present disclosure and the accompanying drawings, and the above description should not be considered to limit the scope of the present invention.

### BRIEF DESCRIPTION OF THE DRAWINGS

The present invention is further described in the detailed description which follows, in reference to the noted plurality of drawings, by way of non-limiting examples of the preferred embodiments of the present invention, in which like characters represent elements throughout the several views of the drawings, and wherein:

FIG. 1 shows an exemplary general computer system that includes a set of instructions for generating, maintaining, re-calculating and archiving a garden plan, as described herein;

FIG. 2 shows an exemplary process flow diagram for obtaining user input for generating a garden plan, according to an aspect of the present disclosure;

FIG. 3 shows an exemplary process flow diagram for obtaining climate data and determining climate information, according to an aspect of the present disclosure;

FIG. 4A shows an exemplary process flow diagram for determining the suitability of a plant variety, according to an aspect of the present disclosure;

FIG. 4B shows an exemplary process flow diagram for determining a season window for the plant variety when using a planting seeds outdoors planting method, according to an aspect of the present disclosure;

FIG. 4C shows an exemplary process flow diagram for determining the suitability of the planting seeds outdoors planting method for the plant variety, according to an aspect of the present disclosure;

FIG. 4D shows an exemplary process flow diagram for determining a season window for the plant variety when using a planting seeds indoors planting method, according to an aspect of the present disclosure;

FIG. 4E shows an exemplary process flow diagram for determining the suitability of the planting seeds indoors planting method for the plant variety, according to an aspect of the present disclosure;

FIG. 4F shows an exemplary process flow diagram for determining a season window for the plant variety when using a planting nursery stock planting method, according to an aspect of the present disclosure;

FIG. 4G shows an exemplary process flow diagram for determining the suitability of the planting nursery stock planting method for the plant variety, according to an aspect of the present disclosure;

FIG. 5A shows an exemplary process flow diagram for adjusting the season window based on frost conditions, according to an aspect of the present disclosure;

FIG. 5B shows an exemplary process flow diagram for adjusting the season window based on sunlight conditions, according to an aspect of the present disclosure;

FIG. 5C shows an exemplary process flow diagram for adjusting the season window based on germination temperature requirements, according to an aspect of the present disclosure;

FIG. 5D shows an exemplary process flow diagram for adjusting the season window based on growth temperature requirements, according to an aspect of the present disclosure;

FIG. 5E shows an exemplary process flow diagram for adjusting the season window based on suitability requirements, according to an aspect of the present disclosure;

FIG. 6A shows an exemplary flow diagram for defining garden bed hardware, according to an aspect of the present disclosure;

FIG. 6B shows an exemplary flow diagram for defining trellis hardware, according to an aspect of the present disclosure;

FIG. 7 shows another exemplary process flow diagram for generating the garden plan, according to an aspect of the present disclosure;

FIG. 8A shows an exemplary flow diagram for evaluating the suitability of a planting, according to an aspect of the present disclosure;

FIG. 8B shows an exemplary flow diagram for selecting an order of planting squares when placing plants in garden beds located in the northern hemisphere, according to an aspect of the present disclosure;

FIG. 8C shows an exemplary flow diagram for selecting an order of planting squares when place plants in garden beds located in the southern hemisphere, according to an aspect of the present disclosure;

FIG. 8D shows an exemplary process for placing plantings in garden beds, according to an aspect of the present disclosure;

FIG. 9A shows an exemplary weekly task list for the garden plan, according to an aspect of the present disclosure;

FIG. 9B shows an exemplary garden layout for the garden plan, according to an aspect of the present disclosure;

FIG. 9C shows an exemplary harvest timeline for the garden plan, according to an aspect of the present disclosure;

FIG. 9D shows an exemplary garden journal planting record for the garden plan, according to an aspect of the present disclosure;

FIG. 9E shows an exemplary garden journal maintenance record for the garden plan, according to an aspect of the present disclosure; and

FIG. 9F shows an exemplary garden journal harvest record for the garden plan, according to an aspect of the present disclosure.

### DETAILED DESCRIPTION

In view of the foregoing, the present disclosure, through one or more of its various aspects, embodiments, and/or specific features or sub-components is thus intended to bring out one or more of the advantages as specifically noted below.

The particulars shown herein are by way of example and for purposes of illustrative discussion of the embodiments of the present disclosure only and are presented in the cause of providing what is believed to be the most useful and readily understood description of the principles and conceptual aspects of the present disclosure. In this regard, no attempt is made to show structural details of the present disclosure in more detail than is necessary for the fundamental understanding of the present disclosure, the description taken with the drawings making apparent to those skilled in the art how the several forms of the present disclosure may be embodied in practice.

Other exemplary embodiments and advantages of the present invention may be ascertained by reviewing the present disclosure and the accompanying drawings, and the above description should not be considered to limit the scope of the present invention.

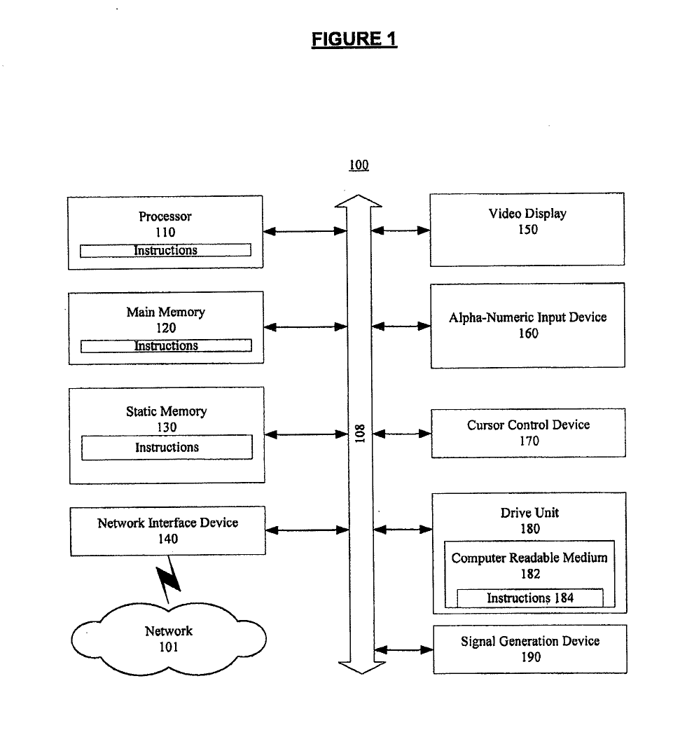

FIG. 1 is an illustrative embodiment of a general computer system that includes a set of instructions for generating a garden plan as described herein. The general computer system is shown and is designated 100. The computer system 100 can include a set of instructions that can be executed to cause the computer system 100 to perform any one or more of the methods or computer based functions disclosed herein. The computer system 100 may operate as a standalone device or may be connected, for example, using a network 101, to other computer systems or peripheral devices. For example, the computer system 100 may include or be included within any one or more of the computers, servers, systems, or communication networks described herein.

In a networked deployment, the computer system may operate in the capacity of a server or as a client user computer in a server-client user network environment, or as a peer computer system in a peer-to-peer (or distributed) network environment. The computer system 100, or portions thereof, can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a personal trusted device, a web appliance, or any other machine capable of executing a set of instructions (sequential or otherwise) that specify actions to be taken by that machine. In a embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 may include a processor 110, for example, a central processing unit (CPU), a graphics processing unit (GPU), or both. Moreover, the computer system 100 can include a main memory 120 and a static memory 130 that can communicate with each other via a bus 108. As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an alpha-numeric input device 160, such as a keyboard, another input device (not shown), such as a remote control device having a wireless keypad, a keyboard, a microphone coupled to a speech recognition engine, a camera such as a video camera or still camera, and a cursor control device 170, such as a mouse. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g. software, can be embedded. A computer-readable medium 182 is a tangible article of manufacture, from which sets of instructions 184 can be read. Further, the instructions 184 may embody one or more of the methods or logic as described herein. In a embodiment, the instructions 184 may reside completely, or at least partially, within the main memory 120, the static memory 130, and/or within the processor 110 during execution by the computer system 100. The main memory 120 and the processor 110 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations, or combinations thereof.

The software may be embedded software that is embedded into a hardware device. For example, embedded software may be embedded into automotive, telecommunications and audio visual devices. Embedded software may be written for special-purpose hardware (e.g., integrated circuit chips, microprocessors). The special-purpose hardware may be used in conjunction with any of the following, but not limited to: robots, appliances, toys, security systems, pacemakers, televisions and digital watches. As will be understood by one of ordinary skill in the art, the special-purpose hardware upon which the embedded software is implemented can be any number of devices that are distinct from a general purpose personal computing device (e.g., a PC).

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 182 that includes instructions 184 or receives and executes instructions 184 responsive to a propagated signal, so that a device connected to a network 101 can communicate voice, video or data over the network 101. Further, the instructions 184 may be transmitted or received over the network 101 via the network interface device 140.

According to a non-limiting aspect of the present disclosure, planning and maintenance of a user garden may be facilitated by planning software that generates one or more of the following: a garden plan; a maintenance plan and a harvest plan. The planning software also includes a comprehensive list of garden hardware (e.g., garden beds, trellises, watering systems, and greenhouses necessary to implement the garden plan) and in another non-limiting embodiment, determines a set garden hardware required to implement the garden plan. The planning software also includes: a seed catalog corresponding to a seed inventory; an Internet-based user forum; a vendor directory of gardening vendors; and an Internet-based knowledge library. The planning software assists a user to determine types of plantings, as well as quantities, locations and timings for planting the same. The planning software also assists the user to maintain and harvest a garden corresponding to the gardening plan. According to another aspect of the present disclosure, the Internet-based user forum allows users to share tips and tricks, as well as garden images. According to yet another aspect of the present disclosure, the Internet-based knowledge library includes images and instructional videos pertaining to supported plant varieties. According to still another aspect of the present disclosure, the vendor directory of gardening vendors includes vendor profiles and contact information for venders selling garden hardware, soil remediation products and other gardening tools and services.

The planning software is installable on at least one web server accessible over the Internet. In an alternative embodiment, the planning software is installable on at least one mobile or at-home computing device. As will be understood by one of ordinary skill in the art, the planning software and various methods described herein are implementable on any tangible physical hardware device upon which a software application is implementable or upon which a set of computer instructions are executable. For example, a tangible physical hardware device is any of the following, but not limited to: a processor, a network element, a server, a computing device, a physical storage and a physical memory. Additionally, as will also be understood by one of ordinary skill in the art, the planning software and various methods described herein are implementable on one or more tangible physical hardware device.

Table 1 illustrates planting variables, planting data and related descriptions, as well as information relating to a plant variety. The planting variables are used, by the planning software, to generate and optimize a garden plan, based on the user's desires and constraints, as will be discussed in further detail hereinbelow.

TABLE 1
illustrates planting variables, description and information relating to each plant variety

| Planting Variable | |
|---|---|
| and Planting Data | Description |
| Category | a category of plant that logically groups plants together |
| Plant Name | a common name for the plant |
| Description | a detailed description of the plant, including heritage and history |
| Planting instructions | instructions on how to plant |
| text | |
| Maintenance | instructions on plant care during a growth period |
| instructions text | |
| Harvest instructions | instructions on how to harvest, including any warning |
| text | conditions (e.g., harvest before flowers appear) |
| Veg/Herb | identifies whether the plant is a vegetable or herb |
| Family | a scientific taxonomy for plants |
| Genus | a scientific taxonomy for plants |
| Species | a scientific taxonomy for plants |
| Variety | a scientific taxonomy for plants |
| Annual or Perennial | a variable specifying whether the plant is grown as an annual or perennial |
| Trellised | a variable specifying whether the plant requires a trellis |
| Harvest Method | a classification describing a harvest behavior of the plant |
| | variety; options include: |
| | harvest-till-temperature (HTT) |
| | range harvest (RH) |
| | single harvest (SH) |
| Harvest Duration | a maximum number of days that the plant can continue to |
| | produce a harvest (HARVEST_{DURATION}). |
| Harvest Interval | a number of days between harvests; for example: |
| | plants requiring a daily harvest have a harvest interval of 1 |
| | plants requiring harvest every other day have a harvest interval of 2 |
| | plants requiring harvest every 3 days have a harvest interval of 3 |
| | plants requiring a weekly harvest have a harvest interval of 7 |
| Maximum Servings | a total number of servings produced during a harvest season (S_{MAX}) |
| Servings per Harvest | a number of servings produced by an average single harvest in a |
| | harvest phase (S_{H}) |
| Serving Size | a size (e.g., 1 cup) of a serving (S) |
| Planting Depth | a depth that a seed is placed during planting |
| Seed Spacing | a recommended spacing between planting seeds after thinning (SP_{S}) |
| Squares per Plant | a number of planting squares required by the plant variety |
| | (SPP); calculated as follows: |
| | SPP = 9 when 24 inches < SP_{S} ≦ 36 inches |
| | SPP = 2 when 12 inches < SP_{S} ≦ 24 inches |
| | SPP = 1 when SP_{S} ≦ 12 inches |
| Plants per Square | a number of plants that can fit in a single square (PPS); |
| | calculated as follows: |
| | PPS =16 when SP_{S} < 3 inches |
| | PPS = 9 when 3 inches < SP_{S} ≦ 4 inches |
| | PPS = 4 when 4 inches < SP_{S} ≦ 6 inches |
| | PPS = 1 when SP_{S} > 6 inches |
| Transplantable | a variable specifying whether the plant variety tolerates being transplanted |
| Preferred Planting | a method of planting preferred (PPM) by the user, either direct |
| Method | sow or transplant |
| Days to Transplant | a number of days from a seed planting date to a date when the |
| | plant is transplanted outside (D_{TRANSPLANT}) |
| Co-Planting Material | other products necessary to support growth of the plant (e.g., |
| | inoculating powder required for beans) |
| Low Soil Temperature | a low range of soil temperature to enable germination (T_{SOIL, LOW}) |
| High Soil | a high range of soil temperature to enable germination (T_{SOIL, HIGH}) |
| Temperature | |
| Low Air Temperature | an air temperature boundary below which the plant will fail to |
| | thrive (T_{AIR, LOW}) |
| High Air Temperature | an air temperature boundary above which the plant will fail to |
| | thrive (T_{AIR, HIGH}) |
| Low Harvest | an air temperature boundary below which the plant will fail to |
| Temperature | produce a harvest (T_{HARVEST, LOW}); applies to plants using the |
| | HTT harvest method |
| High Harvest | an air temperature boundary above which the plant will fail to |
| Temperature | produce a harvest (T_{HARVEST, HIGH}); applies to plants using the |
| | HTT harvest method. |
| Frost Hardiness | a tolerance of the plant to frost |
| | Low: a single frost will kill the plant (FH_{LOW}) |
| | Moderate: the plant can tolerate periodic light frosts (FH_{MED}) |
| | High: frost will not hurt the plant (FH_{HIGH}) |
| Days to Germination | a low range of days to germination (D_{GERM, LOW}) |
| Low | |
| Days to Germination | a high range of days to germination (D_{GERM, HIGH}) |
| High | |
| Days to Maturity Low | a low range of days to maturity, specified from the seed planting |
| | date and not the germination date (D_{MATURITY, LOW}) |
| Days to Maturity High | a high range of days to maturity, specified from the seed |
| | planting date and not the germination date (D_{MATURITY, HIGH}) |
| Latitude Low | for onions, a minimum latitude that the plant can tolerate (LAT_{LOW}) |
| Latitude High | for onions, a maximum latitude that the plant can tolerate (LAT_{HIGH}) |
| Sun | a quantity of sun required by the plant |
| | Shade (SUN_{SHADE}) |
| | Partial Shade to Full Sun (SUN_{PSHADE, FS}) |
| | Full Sun (SUN_{FS}) |
| Minimum Daylight | a minimum number of daylight hours required in order for the |
| Hours | plant to thrive (H_{MIN}) |
| Water | a quantity of water required by the plant |
| | Low to Moderate (W_{LOW}) |
| | Moderate to High (W_{HIGH}) |
| Height Low | a minimum height for the plant (H_{MIN}) |
| Height High | a maximum height for the plant (H_{MAX}) |
| Produce Length Low | a low size (e.g., specified in inches) of produce produced by the plant |
| Produce Length High | a high size (e.g., specified in inches) of produce produced by the plant |
| Weight Low | a low weight range of produce produced by the plant |
| Weight High | a high weight range of produce produced by the plant |
| Cooking instructions | a description of cooking methods |
| Pest reference | images of pests and commentary on prevention and treatment |
| Disease reference | images of plant diseases and commentary on treatment and prevention |
| Good companions | families or varieties of other plants that promote the growth and |
| | development of the plant variety |
| Bad companions | families or varieties of plants that inhibit or prohibit the growth |
| | and development of the plant variety |
| Images of the Plants | images of plants at the following stages |
| | germination |
| | development of true leaves |
| | during periods where maintenance is required to ensure growth |
| | at maturity |

The qualitative and quantitative values of some plant variables shown in Table 1 vary based on the harvest method for the plant variety. Plant varieties having a Harvest-Till-Temperature (HTT) harvest method include plants such as, for example, peas, beans, cucumbers and tomatoes, as well as other plant varieties that grow and produce a harvest until the earlier of (D_{MATURITY, HIGH}+HARVEST_{DURATION}) and the date which temperatures exceed a range of tolerable harvest temperatures. Table 2 illustrates planting variables and related descriptions pertaining to plant varieties having the Harvest-Till-Temperature harvest method.

TABLE 2
illustrates planting variables related to plant varieties having a
Harvest-Till-Temperature harvest method

| Planting Variables | Description |
|---|---|
| Expected Servings per Week | a number of servings per week expected to be produced by a |
| | plant variety during a harvest period; calculated for HTT plant |
| | varieties as: |
| | S_{MAX}/(HARVEST_{DURATION}) * (1/7.0) |
| Succession Planting Frequency | a number of days between successive plantings of the same plant |
| | variety (S_{FREQ}); for HTT plant varieties is calculated as: |
| | S_{FREQ} = HARVEST_{DURATION} |

Plant varieties having a Range Harvest (RH) harvesting method produce a harvest for a specified number of days after a days to maturity date. A key distinction between the Harvest-Till-Temperature harvesting method and the Range Harvest harvesting method is that with respect to the former, one factor causing the harvest to terminate is temperature. With respect to the latter, the sole factor causing the harvest to terminate is time (i.e., an elapsed number of days). Plant varieties having a Range Harvest harvesting method are still subject to temperature limits (e.g., due to a susceptibility of the plant variety to frost). However, regardless of whether temperature limits have been exceeded, a harvest for a plant variety having a Range Harvest harvesting method terminates upon completion of a specified harvest time period. Table 3 illustrates plant variables and related descriptions pertaining to plant varieties having the Range Harvest harvesting method.

TABLE 3
illustrates planting variables related to plants having a Range Harvest method

| Planting Variable | Description |
|---|---|
| Expected Servings per Week | a number of Expected Servings per Week is calculated for plant |
| | varieties having an RH harvesting method as: |
| | S_{MAX}/(HARVEST_{DURATION}/7.0) |
| Succession Planting Frequency | a Succession Planting Frequency (S_{FREQ}) for RH plant varieties |
| | (S_{FREQ}); for RH plant varieties is calculated as: |
| | S_{FREQ} = HARVEST_{DURATION} |

Plant varieties having the Single Harvest method produce a single harvest at maturity for each seed planting (e.g., carrots and beets). Table 4 illustrates planting variables and related descriptions pertaining to plant varieties having the Single Harvest harvesting method.

TABLE 4
illustrates planting variables related to plants having a Single Harvest method

| Planting Variable | Description |
|---|---|
| Expected Servings per Week | Expected Servings per Week for SH plant varieties is set to equal |
| | S_{MAX} |
| Succession Planting Frequency | Succession Planting Frequency (S_{FREQ}) for SH plant varieties is |
| | set to equal to 7 days, since the Required Plantings is based on a |
| | weekly requirement. |

The planning software generates garden plans for each harvest season (e.g., spring/summer and fall/winter). Ignoring short-term directional changes in temperature, spring/summer is a time period of increasing temperatures and fall/winter is a time period of decreasing temperatures. A garden plan is generated for a specific harvest season, such as Spring/Summer 2009, or Fall 2009/Winter 2010. In one embodiment, data for a garden plan is presented in a table format. In another embodiment, instances of the garden plan are archived, insofar as changes may occur that trigger a recalculation of the garden plan. Periodically, older versions of the garden plan are purged. In another embodiment, garden plans for a subsequent harvest season take into consideration any overflow from a prior harvest season. Overflow refers plants planted in a prior harvest season that remain in the ground during a current harvest season. The garden plan is generated by taking into account overflow plants such that available planting squares are allocated to newly planted plants. In another embodiment, overflow plants from a prior harvest season are not considered, in order to preferentially plant plants for the current harvest season.

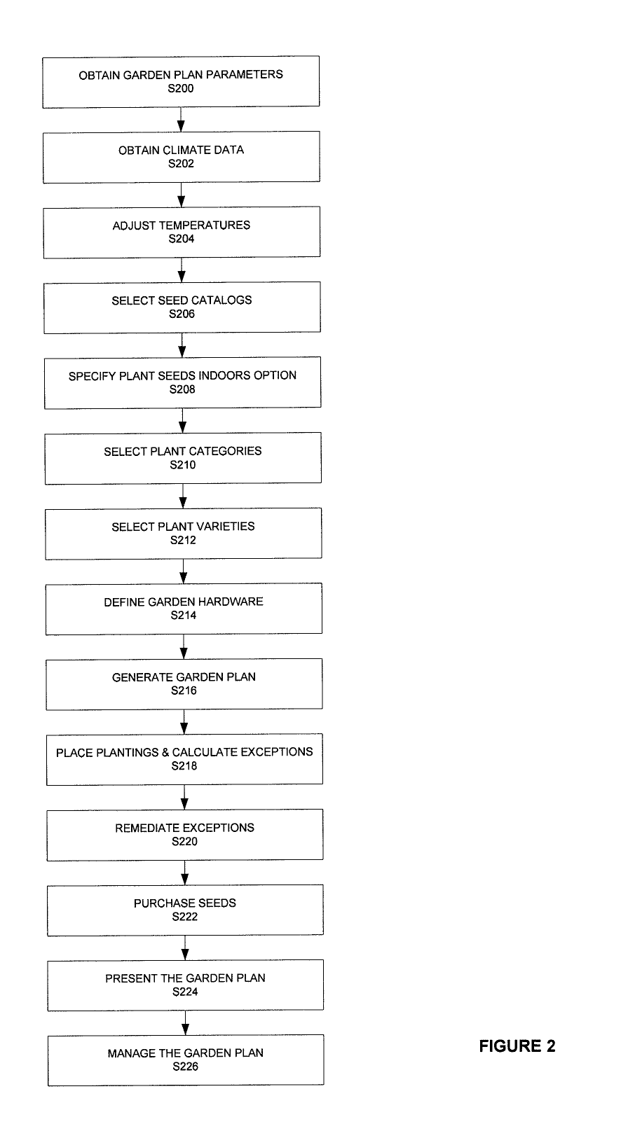

Referring now to FIG. 2, a process flow diagram for obtaining customer input for generating a garden plan is shown. In one embodiment, a user uses a sign-in account in order to store, access, retrieve and modify garden plan data. In step S200, garden plan parameters are obtained from the user, including any of the following, but not limited to: a postal code; a harvest season for which the garden plan is to be generated; a name for the garden plan; the earliest date the user is ready to plant seeds; an offset percentage used to calculate a number of seeds to plant in order to offset the risk of loss due to any of the following, but not limited to: pests, disease and adverse weather conditions (LOSS %); a value for a probability of occurrence for a last frost occurring on a specified spring date for plant varieties with a low tolerance to frost (FROST %_{SPRING, LOW}); a value for a probability of occurrence for a last frost occurring on a specified spring date for plant varieties with a moderate tolerance to frost (FROST %_{SPRING, MODERATE}); a value for a probability of occurrence for a first frost occurring on a specified fall date for plant varieties with a low tolerance to frost (FROST %_{SFALL, LOW}); a value for a probability of occurrence for a first frost occurring on a specified fall date for plant varieties with a moderate tolerance to frost (FROST %_{FALL, MODERATE}); and a percentage of the growth period where air temperatures must remain within a tolerable range for supporting plant growth (SUITABILITY %_{REQUIREMENT}).

As an example of the planting variables discussed above, if LOSS % is selected by the user as 20% and if the user wants 100 servings of a specified plant variety during a harvest season or other predetermined time period, seeds or plants of a sufficient quantity are planted to produce 120 servings of the specified plant variety. As will be understood by one of ordinary skill in the art, any variation of a harvest goal is specifiable by the user to determine a number of seeds, plants or transplants to plant, based on the LOSS %. As an example of the various FROST % variables discussed above, the user sets a probability (e.g., 20%) that a frost will occur. The latest date on which the probability of frost is 20% (e.g., April 15^{th}) is used to determine various planting and harvesting activities that will be discussed in further detail, hereinbelow. As an example of SUITABILITY %_{REQUIREMENT}, the user selects a percentage (e.g., 50%) that indicates that half the days during the growth period for the plant variety must have air temperatures that remain with the tolerable range for supporting plant growth.

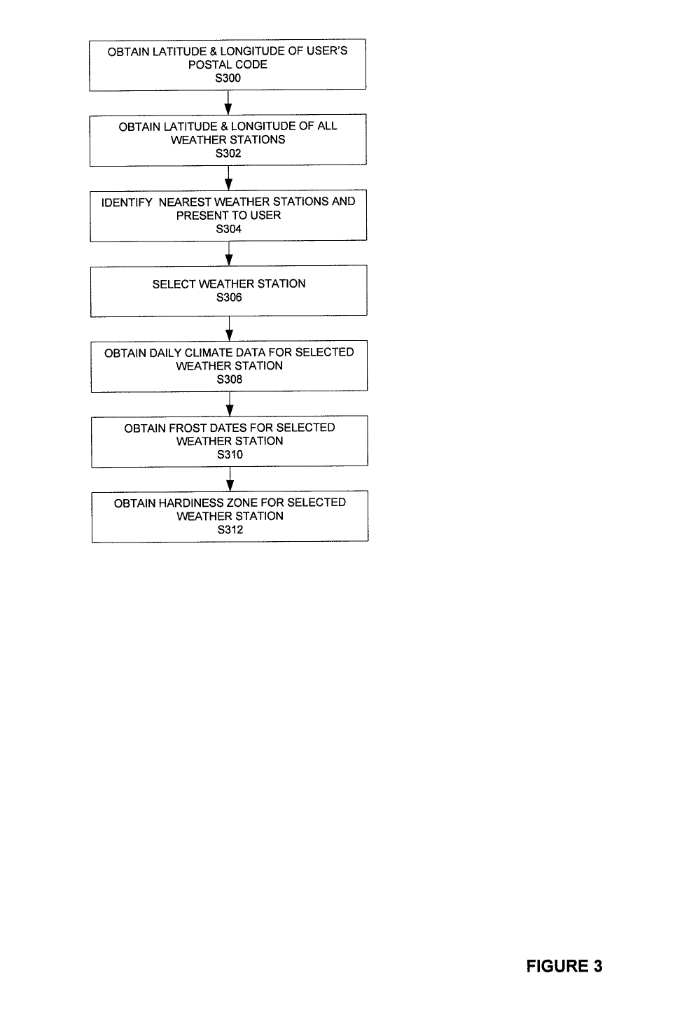

In step S202, climate data is obtained. Referring now to FIG. 3, a process flow diagram for obtaining climate information is shown. The user's postal code is converted into a latitude and longitude address, and this address is used to locate a nearest weather monitoring station from a list of weather monitoring stations maintained by the National Climactic Data Center (NCDC). In one embodiment, the user selects a nearest weather monitoring station as the weather station to use for obtaining climate data for the garden plan. In another embodiment, the user selects an alternative weather monitoring station from the next two, or other predetermined number of, nearest weather monitoring stations. Once the weather monitoring station has been selected, normal climate data for a year time period is obtained, including, but not limited to: daily maximum, minimum, and mean temperatures; annual heating and cooling degree days; average monthly precipitation; a range of dates for the last spring frost based on probabilities of occurrence (e.g., ranging from 10% to 90%); and a range of dates for the first fall frost based on probabilities of occurrence (e.g., ranging from 10% to 90%). In one embodiment, air temperature is used as a best available estimate for soil temperature insofar as germination temperature ranges are relatively broad. A hardiness zone is obtained from, for example, a United States Frost Zone map published by the U.S. Department of Agriculture.

Referring back to FIG. 2, in step S204, the user is presented with the maximum, minimum, and mean temperature for each month based on the weather monitoring station selected in step S202. In one embodiment, the user makes no adjustment to the temperatures. In another embodiment, the user applies an adjustment value to one or more of the maximum, minimum and mean temperatures in order to raise or lower the daily temperatures by the specified amount.

In step S206, the user is presented with a list of seed companies (i.e., seed catalogs) that provide seeds available for purchase via the planning software. The user selects one or more seed catalogs to include in the garden plan.

In step S208, the user is presented with an option to include the planting seeds indoors planting method in the garden plan. This method applies to plants that are transplantable; in this method, seeds are planted indoors and then transplanted outdoors to the garden once a number of Days to Transplant (D_{TRANSPLANT}) has passed. In one embodiment, the user chooses to include the planting seeds indoors planting method. In another embodiment, the user chooses to exclude the planting seeds indoors planting method causing this method to be unavailable for use with the garden plan.

In step S210, the user is presented with a list of plant categories that contain plant varieties available for inclusion in the garden plan. In one embodiment, the user selects one or more plant categories to include in the garden plan. In another embodiment, a category profile page for one or more plant categories is presented to the user and displays information about the plant category including, but not limited to: a description; history; nutritional information; common usages; typical plant varieties; insects and diseases affecting the plant category; and good and bad plant companions for the plant category.

In step S212, the user is presented with a list of plant varieties for each plant category selected in S210. Each plant variety has been evaluated for suitability for inclusion in the garden plan, which is discussed in further detail hereinbelow. Plant varieties are determined to be suitable if the plant variety can tolerate the weather conditions in the user's garden during the plant's germination, growth, and harvest phases. In one non-limiting embodiment, a rating is generated for each of the plant varieties selected by the user. The rating specifies a degree of suitability of the plant with respect to weather conditions at the user location and various other user-related factors. In another non-limiting embodiment, the rating specifies the selected plant variety to be “good”, “fair” or “poor”. As will be understood by one of ordinary skill in the art, any number of levels of ratings may be used. Plant varieties that cannot tolerate these weather conditions are determined to be unsuitable. Unsuitable plant varieties are marked and excluded as options selectable by the user for inclusion in the garden plan. The suitability of a plant variety also depends on the applicability of planting methods to the plant variety. If at least one planting method is applicable to the plant variety, then the plant variety is suitable for use in the garden plan. If no planting methods are applicable to the plant variety, then the plant variety is not suitable for use in the garden plan.

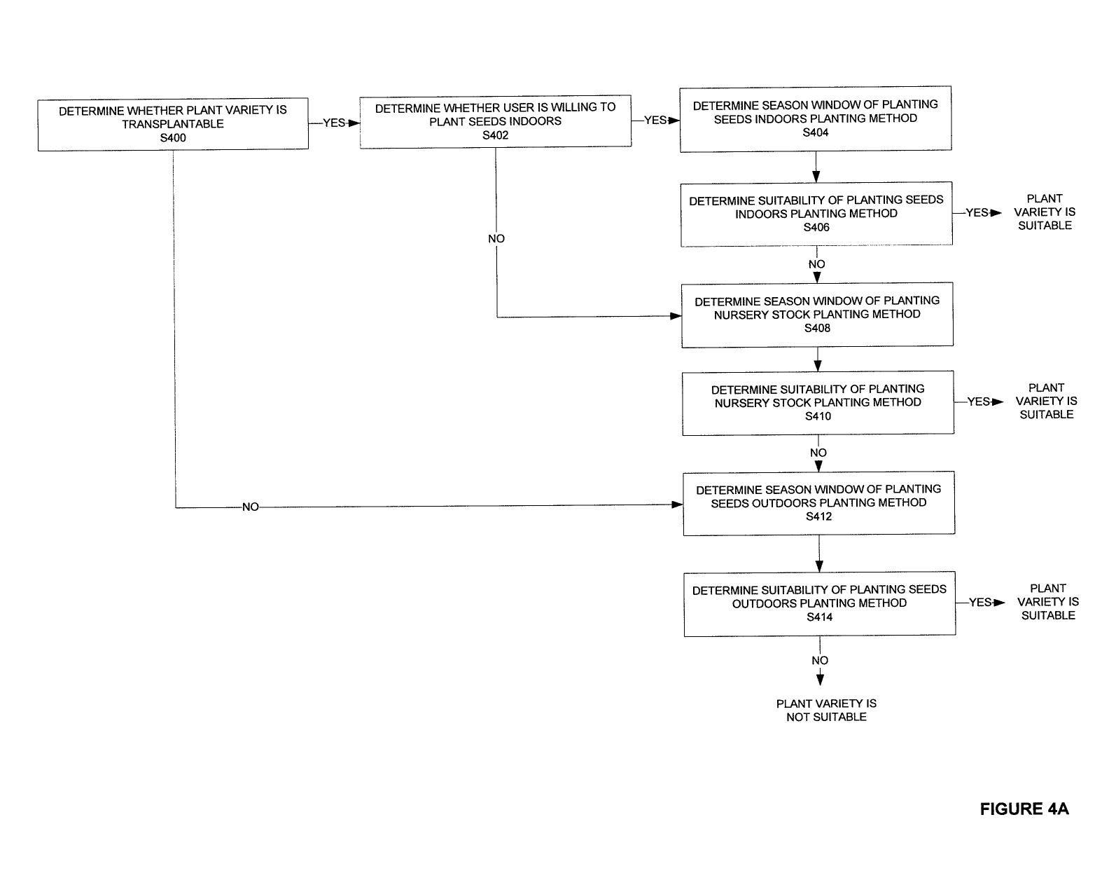

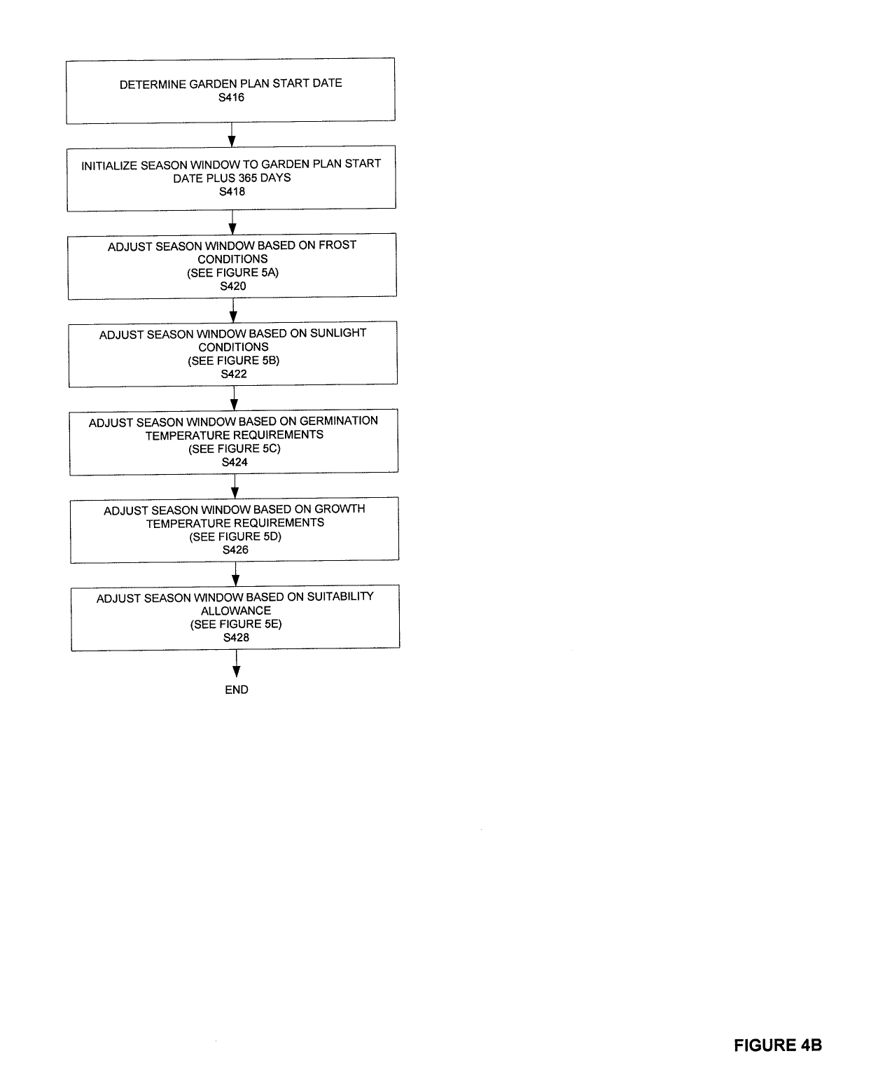

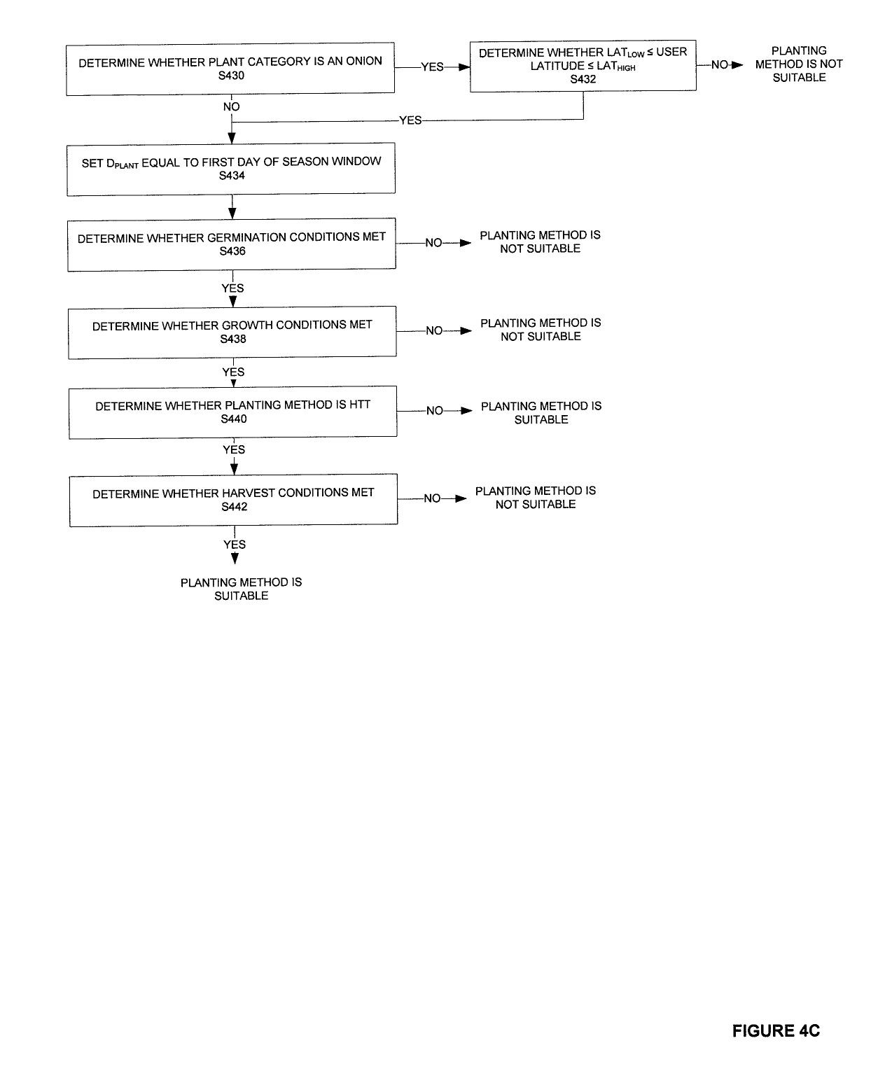

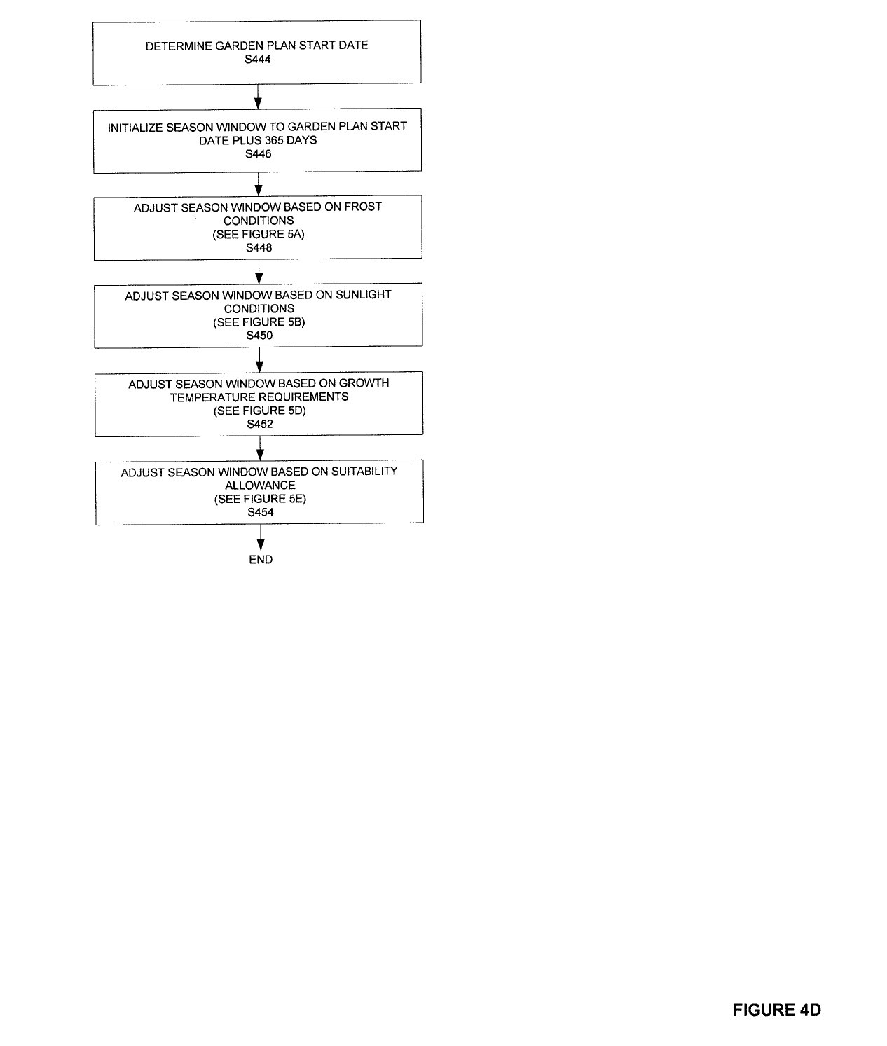

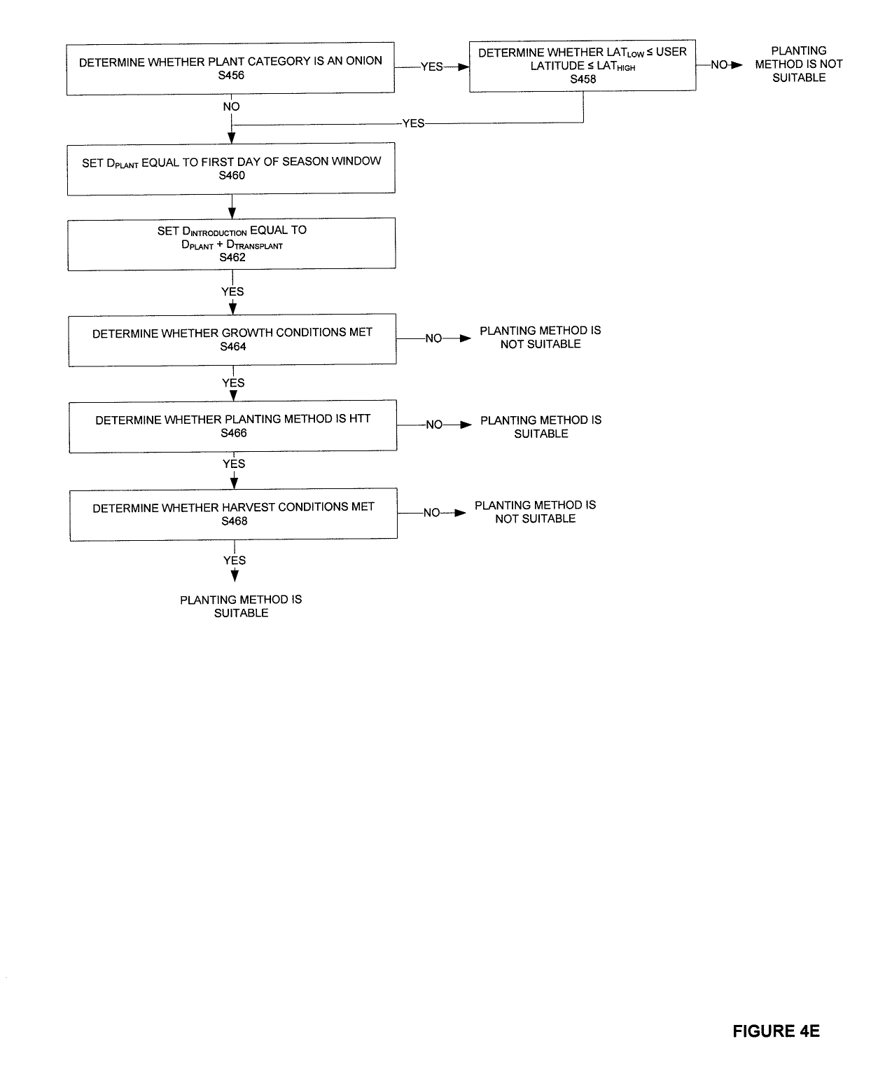

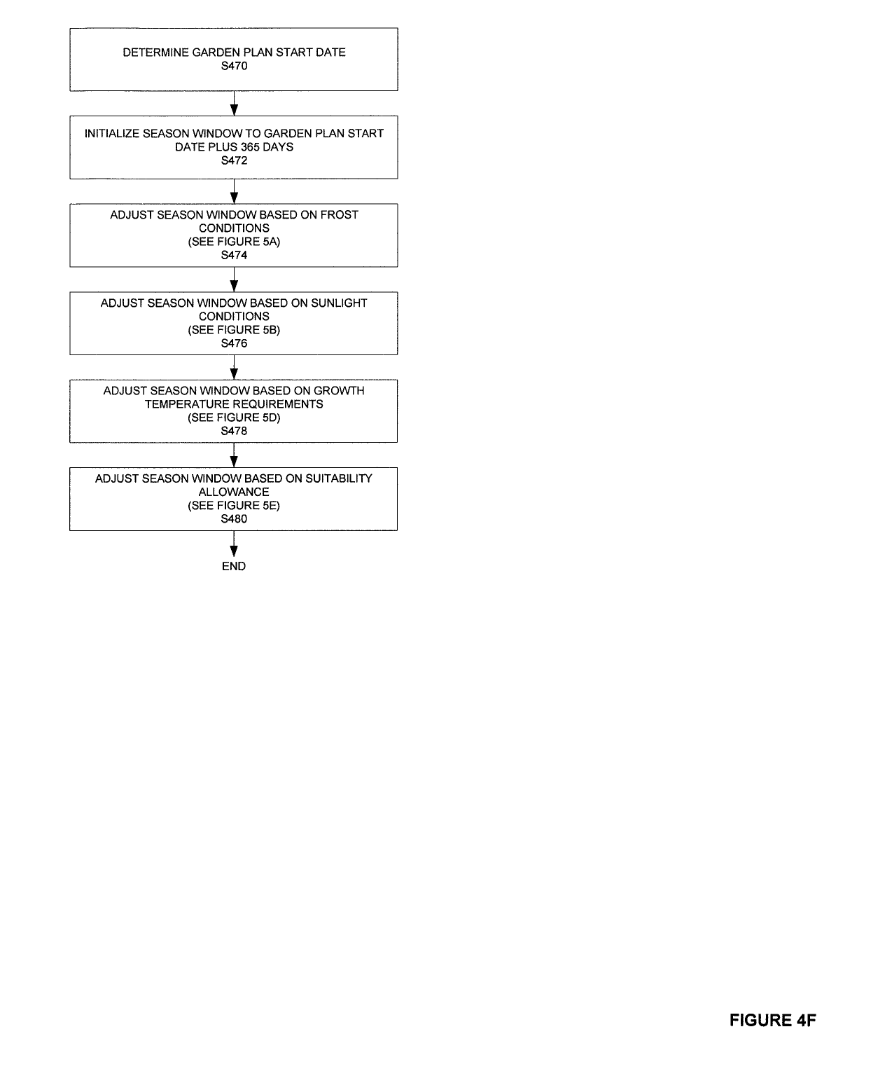

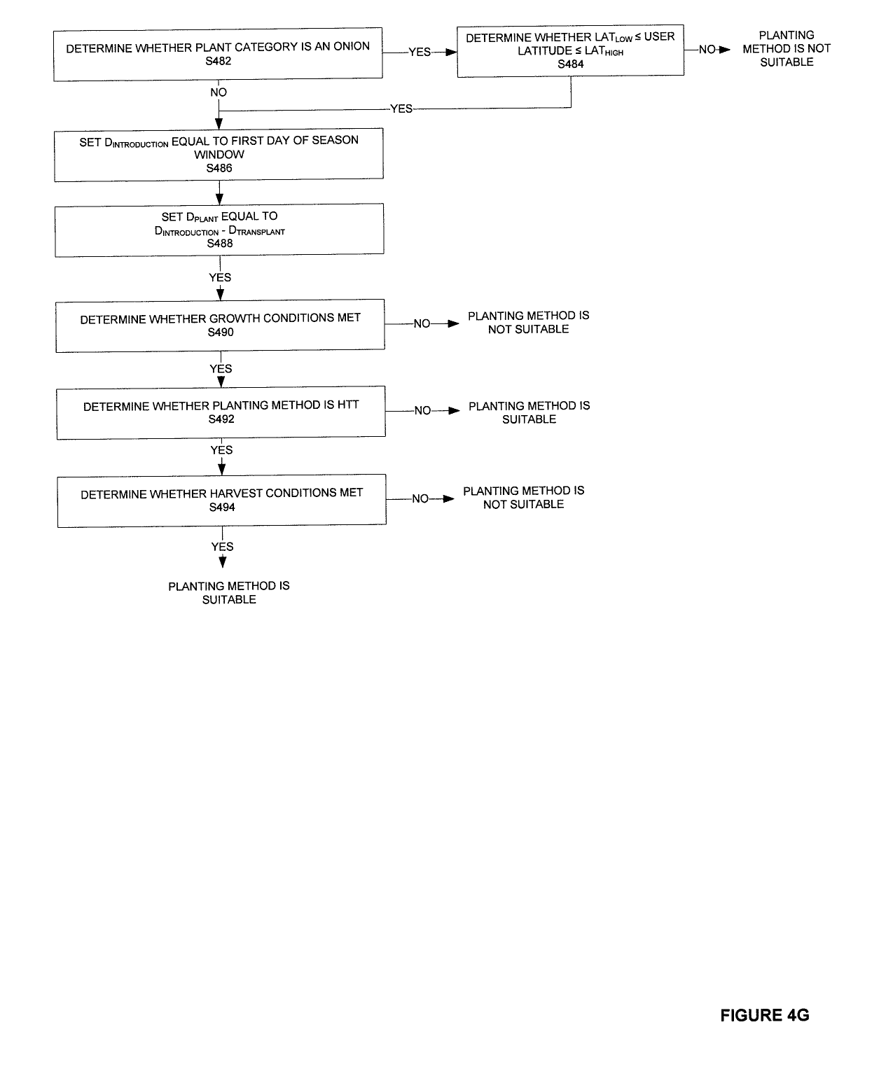

Referring now to FIG. 4A, an exemplary process for determining the suitability of a selected plant variety is shown. In step S400, a transplantable plant variable is checked to determine if the plant variety is transplantable. If the plant variety is not transplantable, then the process continues to step S412, in which a season window (i.e., the range of dates during which the plant variety can survive) is calculated under an assumption the plant variety is planted using the planting seeds outdoors planting method. The planting seeds outdoors planting method indicates that seeds are planted outdoors, directly in the garden, which is discussed in further detail in FIG. 4B. In step S414, the suitability of the planting seeds outdoors planting method is determined, and is presented in detail in FIG. 4C. If the planting method is suitable, then the plant variety is deemed to be suitable and the planting seeds outdoors planting method is selectable as the planting method for the plant variety. If the planting method is not suitable, then the plant variety is deemed to be unsuitable for use in the garden plan.

Referring back to step S400, if the plant variety is transplantable, then in step S402, a determination is made as to whether the user is willing to use the planting seeds indoors planting method by checking the user's input to step S208 on FIG. 2. If the user is not willing to use the planting seeds indoors planting method, then the process continues to step S408 in FIG. 4A, in which the season window is calculated assuming the plant variety is planted using the planting nursery stock planting method. The planting nursery stock planting method means that plants (as opposed to seeds) are planted outdoors in the garden, which is discussed in detail in FIG. 4F. In step S410, the suitability of the planting nursery stock planting method is determined and is presented in detail in FIG. 4G. If the planting method is suitable, then the plant variety is deemed to be suitable for use with the garden plan and the planting nursery stock planting method is selectable as the planting method for this plant variety. The process continues to step S412 in which the season window is calculated assuming the plant variety is planted using the planting seeds outdoors planting method. In step S414, the suitability of the planting seeds outdoors planting method is determined. If the selected planting method is suitable, then the plant variety is deemed to be suitable for use with the garden plan and the planting seeds outdoors planting method is selectable as the planting method for the plant variety. If at the conclusion of step S414 no planting methods were determined to be suitable, then the plant variety is deemed to be unsuitable for use with the garden plan.

Referring back to step S402, if the user is willing to use the planting seeds indoors planting method, then the process continues to step S404, in which the season window is calculated under an assumption that the plant variety is planted using the planting seeds indoors planting method, and is presented in detail in FIG. 4D. In step S406, the suitability of the planting seeds indoors planting method is determined, and is presented in detail in FIG. 4E. If the planting method is suitable, then the plant variety is deemed to be suitable for use with the garden plan and the planting seeds indoors planting method is selectable as the planting method for the plant variety. The process continues to step S408, in which the season window is calculated assuming the plant variety is planted using the planting nursery stock planting method. In step S410, the suitability of the planting nursery stock planting method is determined. If the planting method is suitable, then the plant variety is deemed to be suitable for use with the garden plan and the planting nursery stock planting method is selectable as the planting method for this plant variety. The process continues to step S412 in which the season window is calculated assuming the plant variety is planted using the planting seeds outdoors planting method. In step S414, the suitability of the planting seeds outdoors planting method is determined. If the planting method is suitable, then the plant variety is deemed to be suitable for use with the garden plan and the planting nursery stock planting method is selectable as the planting method for this plant variety. If at the conclusion of step S414 no planting methods were determined to be suitable, then the planting variety is deemed to be unsuitable for use with the garden plan.

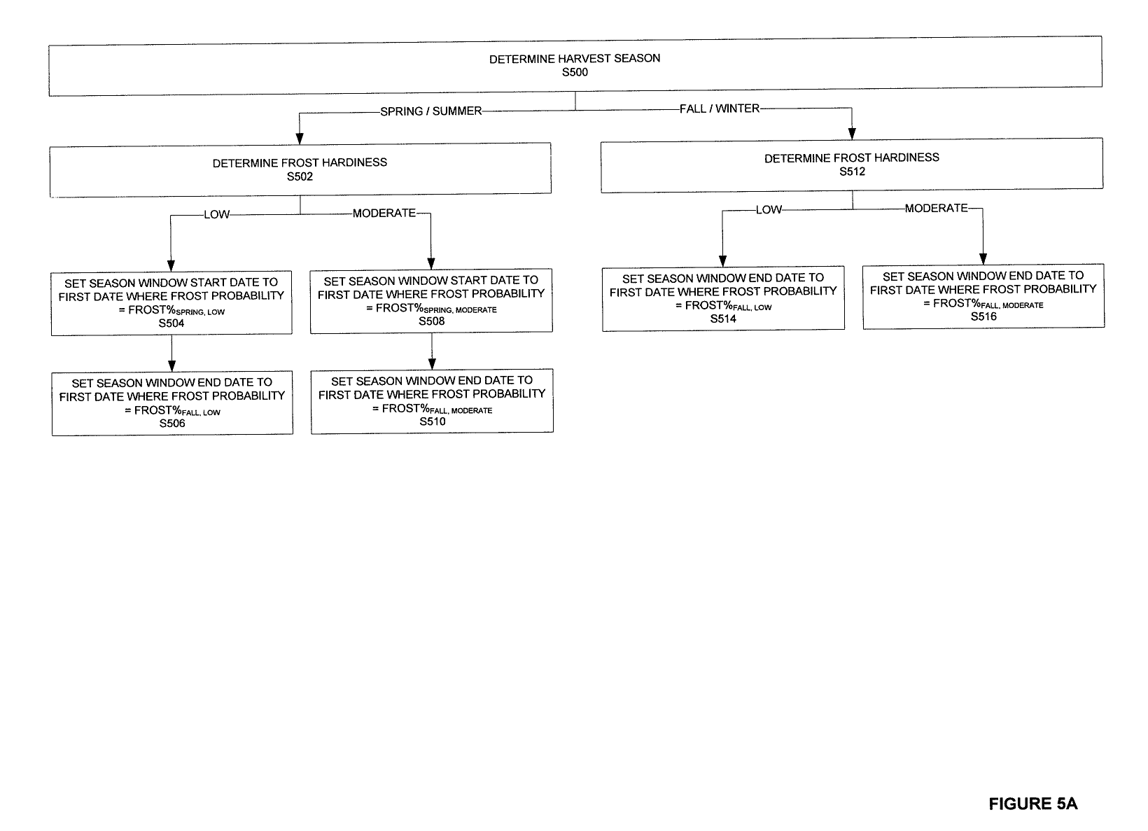

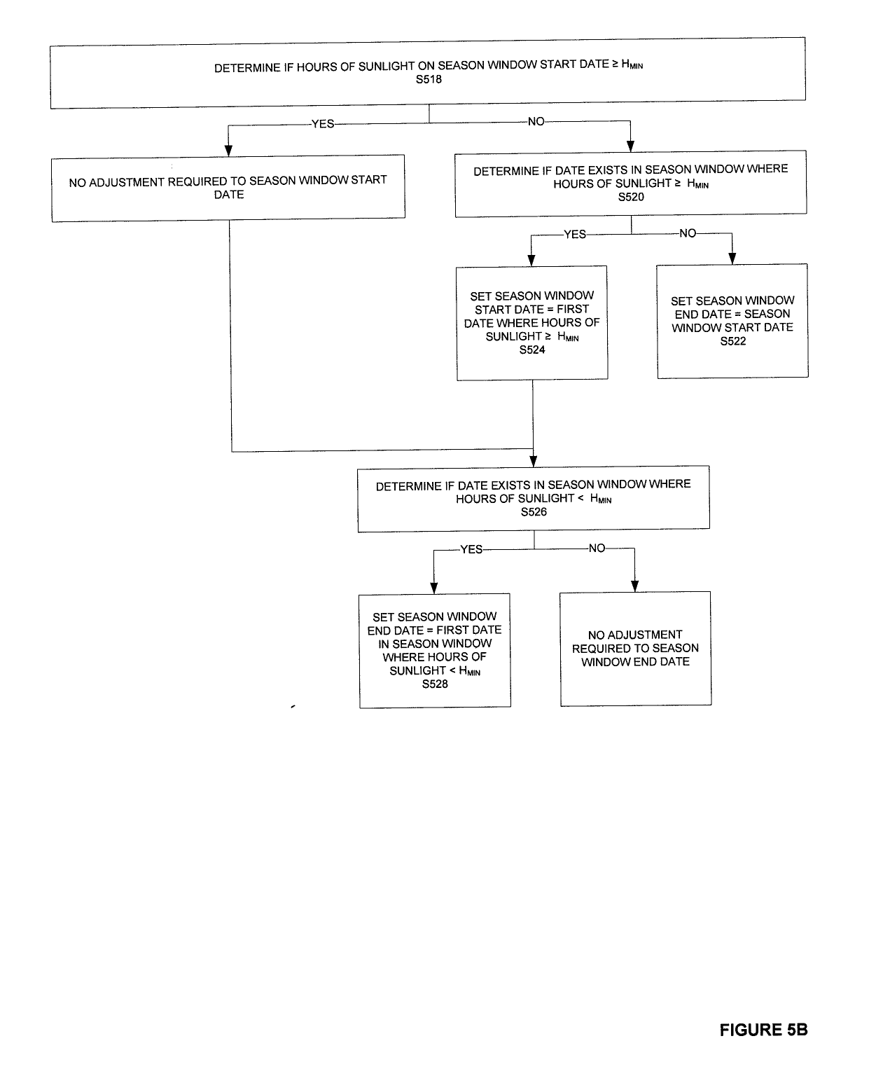

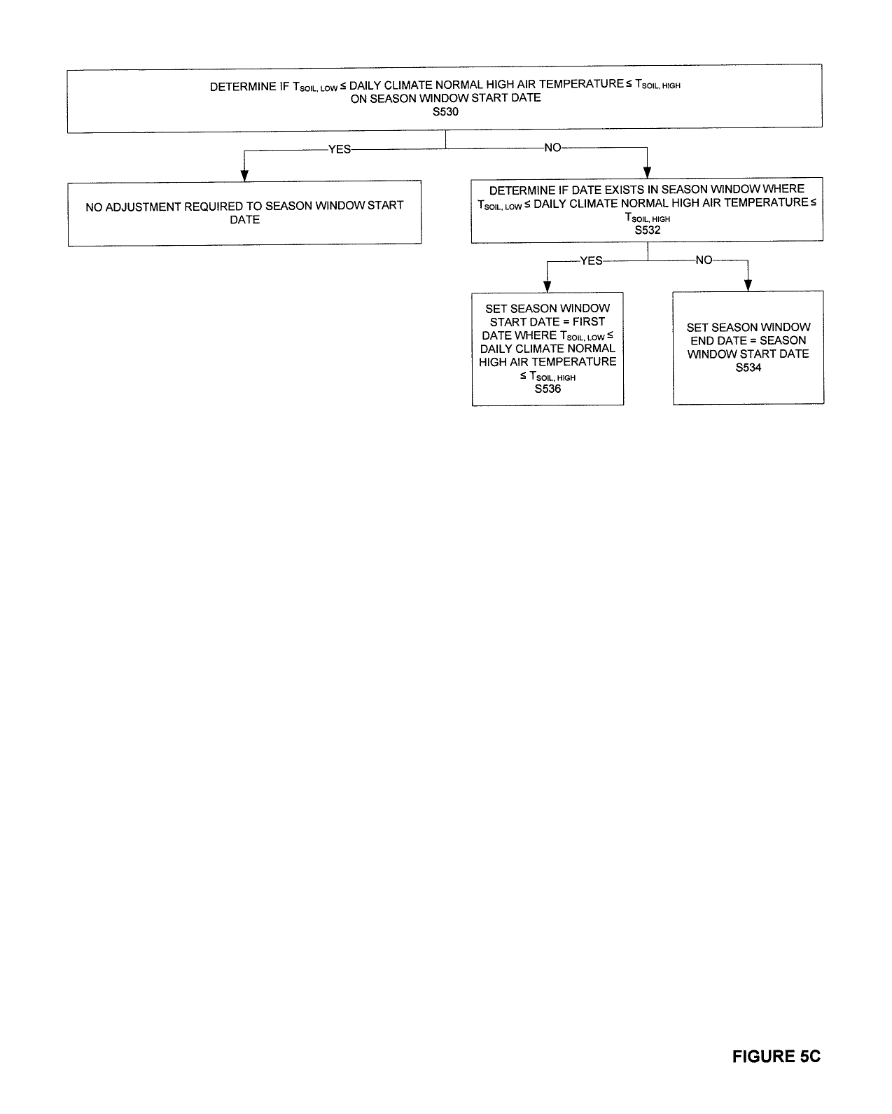

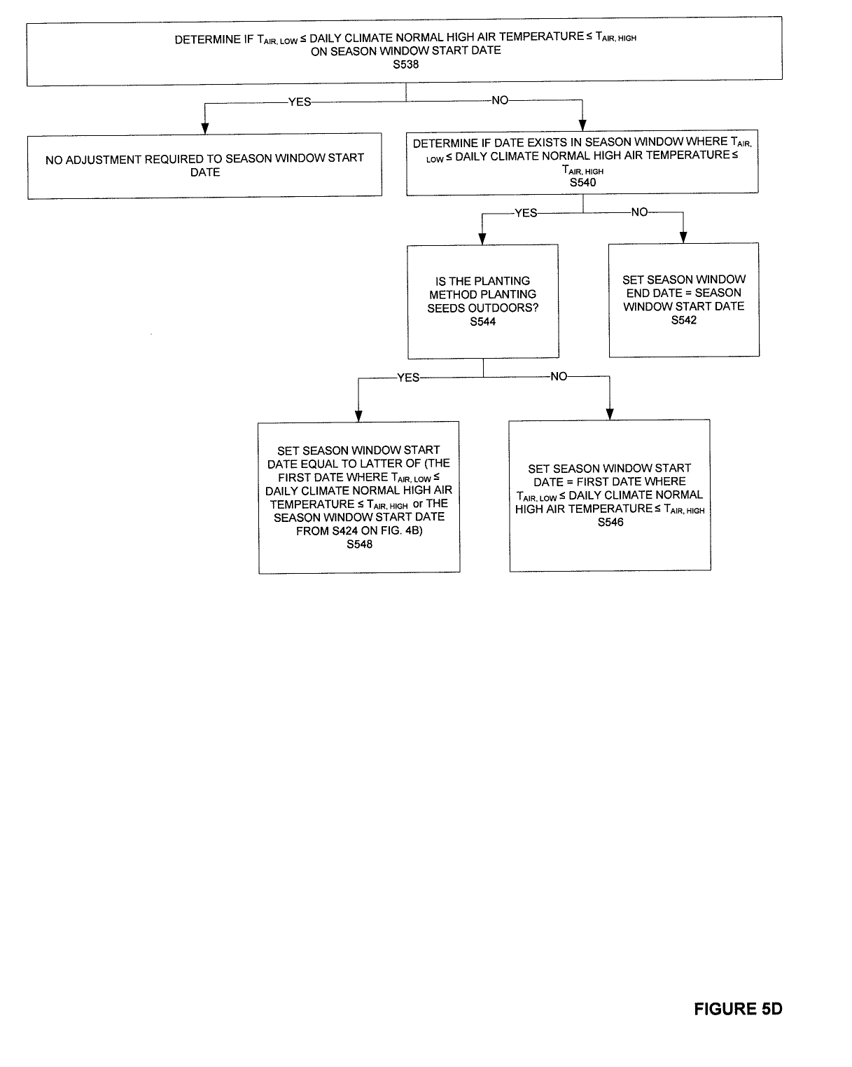

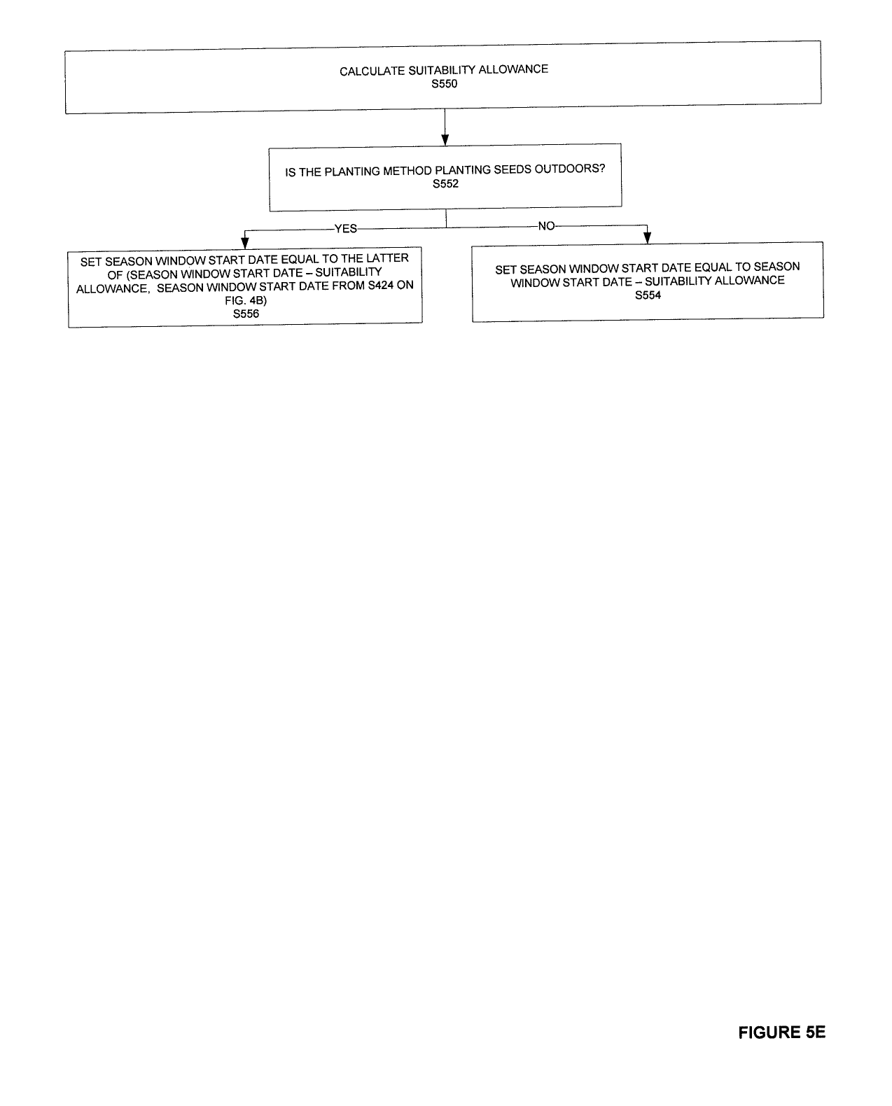

Referring now to FIG. 4B, an exemplary process for determining the season window for the planting seeds outdoors planting method for a selected plant variety is shown. In step S416, the garden plan start date is set to equal the latter of the start date of the harvest season for which the garden plan is being generated, or the earliest date the user is willing to plant seeds, which is determined from a garden plan parameters obtained from the user in step S200 in FIG. 2. In step S418, the season window is set to equal the garden plan start date plus 365 days, establishing an initial date range during which a plant variety must be planted, grown, and harvested in order to be suitable for the garden plan. In step S420, the season window is adjusted based on frost conditions, delaying the beginning of the season window or moving up the end of the season window in cases where a plant variety is sensitive to frost and the climate data indicates a probability that frost will occur. The details of the frost adjustment are shown in FIG. 5A. In step S422, the season window is adjusted based on sunlight conditions, delaying the beginning of the season window or moving up the end of the season window in cases where the hours of daylight are not sufficient to meet the plant variety's sunlight requirements. The details of the sunlight adjustment are shown in FIG. 5B. In step S424, the season window is adjusted based on germination temperature requirements, delaying the beginning of the season window in cases where the soil temperatures are not sufficient to meet the plant variety's germination requirements. The details of the germination temperature adjustment are shown in FIG. 5C. In step S426, the season window is adjusted based on growth temperature requirements for the plant variety, delaying the beginning of the season window in cases where the air temperatures are not sufficient to meet the plant variety's growth temperature requirements. The details of the growth temperature adjustment are shown in FIG. 5D. In step S428, the season window is adjusted based on a suitability requirement, subtracting days from the beginning of the season window in cases where the SUITABILITY %_{REQUIREMENT} specified by the user in step S200 is less than 100%. The details of adjusting based on a suitability requirement adjustment are shown in FIG. 5E.

Referring now to FIG. 4C, an exemplary process for determining the suitability of the planting seeds outdoors planting method for a selected plant variety is shown. In step S430, if the selected plant variety belongs to the onion plant category, then it is determined, in step S432, whether the user's geographic location is located between a minimum latitude that the plant can tolerate (LAT_{LOW}) and a maximum latitude that the plant can tolerate (LAT_{HIGH}). If the user's geographic location is not located between LAT_{LOW} and LAT_{HIGH}, then the planting seeds outdoors planting method is not suitable for this plant variety. If the user is located between LAT_{LOW} and LAT_{HIGH}, then in step S434, the plant date (D_{PLANT}) value is set to equal to the first day of the season window determined in step S428 in FIG. 4B. In step S436, a determination of whether germination conditions have been met for the plant variety occurs by comparing the soil temperature requirements of the plant variety to the daily climate normal high air temperature during the germination period. The germination period is defined as D_{PLANT} D_{GERM, HIGH}. The soil temperature requirements are deemed to have if EQ. 1 is satisfied on at least one day during the germination period.

T_{SOIL,LOW}≦daily climate normal high air temperature≦T_{SOIL,HIGH} (EQ. 1)

If the germination conditions have not been met, the planting seeds outdoors planting method is not suitable for this plant variety. In step S438, a determination of whether growth conditions have been met occurs for the plant variety by comparing the air temperature requirements of the plant variety to the daily climate normal high air temperature during the growth period. The growth period is defined as D_{PLANT} D_{MATURITY, HIGH}. The air temperature requirements are deemed to have been met if a number of days (N), during the growth period, for which EQ. 2 is satisfied, also satisfies the inequality set forth in EQ. 3.

T_{AIR,LOW}≦daily climate normal high air temperature≦T_{AIR,HIGH} (EQ. 2)

N≧D_{MATURITY,HIGH}*SUITABILITY %_{REQUIREMENT} (EQ. 3)

If growth conditions have not been met, the planting seeds outdoors planting method is not suitable for the selected plant variety.

In step S440, the harvest method for the plant variety is checked. If the harvest method is Range Harvest or Single Harvest, the planting seeds outdoors planting method is determined to be suitable for the selected plant variety. If the harvest method is Harvest-Till-Temperature, then the process proceeds to step S442 at which it is determined whether harvest conditions have been met for the plant variety (i.e., by comparing the harvest temperature requirements of the plant variety to the daily climate normal high air temperature on the first day of harvest, defined as D_{PLANT}+D_{MATURITY, LOW}. The requirements are deemed to have been met if EQ. 2 is satisfied, on the first day of harvest. If harvest conditions have not been met, the planting seeds outdoors planting method is not suitable for the selected plant variety. Otherwise, the planting seeds outdoors planting method is suitable for the selected plant variety.

Referring now to FIG. 4D, an exemplary process for determining the season window of the planting seeds indoors planting method for the plant variety is shown. In step S444, the garden plan start date is set to equal the latter of the start date of the harvest season for which the garden plan is being generated, or the earliest date the user is willing to plant seeds, which is a garden plan parameter obtained from the user in step S200 in FIG. 2. In step S446, the season window is set to equal the garden plan start date plus 365 days, establishing the initial date range during which a plant variety must be planted, grown, and harvested in order to be suitable for the garden plan. In step S448, the season window is adjusted based on frost conditions, delaying the beginning of the season window or moving up the end of the season window in cases where a plant variety is sensitive to frost and the climate data indicates a probability that frost will occur. The details of frost adjustment are shown in FIG. 5A. In step S450, the season window is adjusted based on sunlight conditions, delaying the beginning of the season window or moving up the end of the season window in cases where the hours of daylight are not sufficient to meet the plant variety's sunlight requirements. The details of sunlight adjustment are shown in FIG. 5B. In step S452, the season window is adjusted based on growth temperature requirements, delaying the beginning of the season window in cases where the air temperatures are not sufficient to meet the plant variety's growth temperature requirements. The details of growth temperature adjustment are shown in FIG. 5D. In step S454, the season window is adjusted based on the suitability requirement, subtracting days from the beginning of the season window in cases where the SUITABILITY %_{REQUIREMENT} specified by the user in step S200 is less than 100%. The details of adjusting suitability requirements are shown in FIG. 5E.

Referring now to FIG. 4E, an exemplary process for determining the suitability of the planting seeds indoors planting method for a selected plant variety is shown. In step S456, if the plant variety belongs to the onion plant category, then it is determined, in step S458, whether the user is located between a minimum latitude that the plant variety can tolerate (LAT_{LOW}) and a maximum latitude that the plant variety can tolerate (LAT_{HIGH}). If the user is not located between LAT_{LOW} and LAT_{HIGH}, then the planting seeds indoors planting method is not suitable for the plant variety. If the user is located between LAT_{LOW} and LAT_{HIGH}, in step S460, the plant date (D_{PLANT}) value is set to equal to the first day of the adjusted season window determined in step S454 in FIG. 4D. In step S462, the introduction date (D_{INTRODUCTION}) is determined according to EQ. 4.

D_{INTRODUCTION}=D_{PLANT}+D_{TRANSPLANT} (EQ. 4)

In step S464, it is determined whether growth conditions have been met for the plant variety by comparing the air temperature requirements of the plant variety to the daily climate normal high air temperature during which the plant variety is grown outside (D_{OUTSIDE}), also termed an outside growth period, which is calculated according to EQ. 5.

D_{OUTSIDE}=D_{INTRODUCTION}+D_{MATURITY,HIGH}−D_{TRANSPLANT} (EQ. 5)

The requirements are deemed to have been met if a number of days (N) during the outside growth period (D_{OUTSIDE}) satisfying EQ. 2 also satisfies EQ. 3. If growth conditions have not been met, the planting seeds indoors planting method is not suitable for the selected plant variety. In step S466, the harvest method for the plant variety is checked. If the harvest method is Range Harvest or Single Harvest, the planting seeds indoors planting method is suitable for the selected plant variety. If the harvest method is harvest-till-temperature, then the process proceeds to step S468 at which a determination of whether harvest conditions have been met for the plant variety is made by comparing the harvest temperature requirements of the plant variety to the daily climate normal high air temperature on the first day of harvest (D_{PLANT}+D_{MATURITY, LOW}). The requirements are deemed to have been met if EQ. 2 is satisfied on the first day of harvest. If harvest conditions have not been met, the planting seeds indoors planting method is not suitable for this plant variety. Otherwise, the planting seeds indoors planting method is suitable for this plant variety.

Referring now to FIG. 4F, an exemplary process for determining the season window of the planting nursery stock planting method for a selected plant variety is shown. In step S470, the garden plan start date is set to equal the latter of the start date of the harvest season for which the garden plan is being generated, or the earliest date the user would be willing to plant seeds, which is a garden plan parameter obtained from the user in step S200 in FIG. 2. In step S472, the season window is set to equal the garden plan start date plus 365 days, establishing an initial date range during which a plant variety must be planted, grown, and harvested in order to be suitable for the garden plan. In step S474, the season window is adjusted based on frost conditions, delaying the beginning of the season window or moving up the end of the season window in cases where a plant variety is sensitive to frost and the climate data indicates a probability that frost will occur. The details of the frost adjustment are shown in FIG. 5A. In step S476, the season window is adjusted based on sunlight conditions, delaying the beginning of the season window or moving up the end of the season window in cases where the hours of daylight are not sufficient to meet the plant variety's sunlight requirements. The details of the sunlight adjustment are shown in FIG. 5B. In step S478, the season window is adjusted based on the growth temperature requirements, delaying the beginning of the season window in cases where the air temperatures are not sufficient to meet the plant variety's growth temperature requirements. The details of the growth temperature adjustment are shown in FIG. 5D. In step S480, the season window is adjusted based on the suitability allowance, subtracting days from the beginning of the season window in cases where the SUITABILITY %_{REQUIREMENT} specified by the user in step S200 is less than 100%. The details of the suitability requirement adjustment are shown in FIG. 5E.

Referring now to FIG. 4G, an exemplary process for determining the suitability of the planting nursery stock planting method for the plant variety is shown. In step S482, if the plant variety belongs to the onion plant category, then it is determined, in step S484, whether the user is located between a minimum latitude that the plant can tolerate (LAT_{LOW}) and a maximum latitude that the plant can tolerate (LAT_{HIGH}). If the user is not located between LAT_{LOW} and LAT_{HIGH}, then the planting seeds indoors planting method is not suitable for the selected plant variety. If the user is located between LAT_{LOW} and LAT_{HIGH}, in step S486, the introduction date (D_{INTRODUCTION}) value is set to equal to the first day of the adjusted season window determined in step S480 on FIG. 4F. In step S488, the plant date (D_{PLANT}) value is determined according to EQ. 6.

D_{PLANT}=D_{INTRODUCTION}−D_{TRANSPLANT} (EQ. 6)

In step S490, it is determined whether growth conditions have been met for the plant variety by comparing the air temperature requirements of the plant variety to the daily climate normal high air temperature during the outside growth period (D_{OUTSIDE}) which is determined according to EQ. 5. The requirements are deemed to have been met if the number of days (N) during the outside growth period for which EQ. 2 is satisfied also satisfies EQ. 3. If growth conditions have not been met, the planting nursery stock planting method is not suitable for the selected plant variety. In step S492, the harvest method for the plant variety is checked. If the harvest method is Range Harvest or Single Harvest, the planting nursery stock planting method is suitable for the plant variety. If the harvest method is harvest-till-temperature, then the process proceeds to step S494 at which it is determined whether harvest conditions have been met for the plant variety occurs by comparing the harvest temperature requirements of the plant variety to the daily climate normal high air temperature on the first day of harvest (D_{PLANT}+D_{MATURITY}, LOW). The requirements are deemed to have been met if EQ. 2 is satisfied on the first day of harvest. If harvest conditions have not been met, the planting nursery stock planting method is not suitable for the selected plant variety. Otherwise, the planting nursery stock planting method is suitable for the selected plant variety.

In FIG. 5A, an exemplary process for adjusting the season window based on frost conditions is shown. The harvest season is determined in step S500. If the season is spring/summer, then the process proceeds to step S502, where the frost hardiness of the plant variety is determined. If the plant has a low tolerance for frost (e.g., the frost hardiness is low and a single frost will kill the plant), the season window start date is set in step S504 to the first date where the frost probability matches the FROST %_{SPRING, LOW} value provided by the user in step S200 on FIG. 2. Then, in step S506, the season window end date is set to the first date where the frost probability matches the FROST %_{FALL, LOW} value provided by the user in step S200 on FIG. 2. If the plant variety has a moderate tolerance for frost (e.g., the frost hardiness is moderate and the plant variety can tolerate periodic, light frosts), the season window start date is set in step S508 to the first date where the frost probability matches the FROST %_{SPRING, MODERATE} value provided by the user in step S200 on FIG. 2. Then, in step S510, the season window end date is set to the first date where the frost probability matches the FROST %_{FALL, MODERATE} value provided by the user in step S200 on FIG. 2. Returning back to step S500, if the season is fall/winter, then the process proceeds to step S512, where the frost hardiness of the plant variety is determined. If the plant variety has a low tolerance for frost (e.g., the frost hardiness is low and a single frost will kill the plant), the season window start date is set in step S514 to the first date where the frost probability matches the FROST %_{FALL, LOW} value provided by the user in step S200 on FIG. 2. If the plant variety has a moderate tolerance for frost (e.g., the frost hardiness is moderate and the plant can tolerate periodic, light frosts), the season window start date is set, in step S516, to the first date where the frost probability matches the FROST %_{FALL, MODERATE} value provided by the user in step S200 on FIG. 2.

In FIG. 5B, an exemplary process for adjusting the season window based on sunlight conditions is shown. In step S18, the hours of sunlight for the season window start date (determined based on the climate normal data obtained in step S202 on FIG. 2) are compared to the minimum daylight hours (H_{MIN}) associated with the plant variety. If the daily climate normal hours of sunlight are greater than or equal to H_{MIN}, then no adjustment is required to the season window start date and the process proceeds to step S526, where the number of hours of sunlight for each date in the season window are compared to H_{MIN}. If any date exists in the season window where the hours of sunlight is less than H_{MIN}, then in step S528, the season window end date is adjusted to the first date during which such condition occurs. If no dates exist for which the hours of sunlight is less than H_{MIN}, then no adjustment is required to the season window end date.

Returning back to step S518, if the hours of sunlight occurring during the season window start date are less than H_{MIN}, then all dates in the season window are checked in step S520 to determine if any date exists where the hours of sunlight are greater than or equal to H_{MIN}. If not, then the season window end date in step S522 is set to equal the season window start date. If one or more dates do exist in the season window where the hours of sunlight are greater than or equal to H_{MIN}, then the season window start date is adjusted tot eh first date during which such condition occurs, and the process proceeds to step S526, in which the hours of sunlight occurring on each date in the season window are compared to H_{MIN}. If any date exists in the season window where the hours of sunlight is less than H_{MIN}, then in step S528, the season window end date is set to the first date when such condition occurs. If no dates exist (i.e., where the hours of sunlight is less than H_{MIN}), then no adjustment is required to the season window end date.

In FIG. 5C, an exemplary process for adjusting the season window based on germination temperature requirements is shown. In step S530, the daily climate normal high air temperature is compared to the low and high germination temperature requirements of the plant variety (T_{SOIL, LOW} and T_{SOIL, HIGH}). No adjustment is required to the season window start date if EQ. 1 is satisfied. If climate normal high air temperature is greater than T_{SOIL, HIGH} or less than T_{SOIL, LOW}, then the process proceeds to step S532 where all dates in the season window are checked to determine if any date satisfies EQ. 15. If no dates exist where EQ. 1 is satisfied, then the season window end date is set to equal the season window start date in step S34. If one or more dates exist where EQ. 1 is satisfied, then in step S536, the season window start date is set to the first date in the season window at which such condition is met.

In FIG. 5D, an exemplary process for adjusting the season window based on growth temperature requirements is shown. In step S538, the daily climate normal high air temperature is compared to the low and high air temperature requirements of the plant variety (T_{AIR, LOW} and T_{AIR, HIGH}). If EQ. 2 is satisfied, then no adjustment is required for the season window start date. If the daily climate normal high air temperature is greater than T_{AIR, HIGH} or is less than T_{AIR, LOW}, then the process proceeds to step S540 where all dates in the season window are checked to determine if any date exists for which EQ. 16 is satisfied. If no dates exist for which EQ. 2 is satisfied, then the season window end date is set to equal the season window start date in step S542. If one or more dates exist for which EQ. 3 is satisfied, then in step S544, the planting method is checked. If the planting method is planting seeds outdoors, then in step S548, the season window start date is set to the latter of the first date during which EQ. 3 is satisfied, or the season window start date from step S424 on FIG. 4B. If the planting method is not planting seeds outdoors, then in steps S546, the season window start date is set to the first date in the season window during which EQ. 16 is satisfied.

In FIG. 5E, an exemplary process for adjusting the season window based on suitability requirements is shown. The suitability allowance is calculated in step S550 by multiplying D_{MATURITY, HIGH} (a planting variable indicating a high value for days to maturity for the selected plant variety) by the SUITABILITY %_{REQUIREMENT}. In step S552, the planting method is checked. If the method is not planting seeds outdoors, then in step S554, the suitability allowance is subtracted from the season window start date. If the planting method is planting seeds outdoors, then the season window start date is set to the latter of season window start date less the suitability allowance) or the season window start date determined from step S436 in FIG. 4C.

Subsequently, the process continues with selecting plant varieties. Referring back to step S212 in FIG. 2, in one embodiment, the user selects one or more plant varieties to include in the garden plan. In another embodiment, the user edits attributes of existing plant varieties in order to create personalized, custom versions of these varieties for use in the garden plan. In another embodiment, users add their own custom plant varieties and manually specify each attribute (for the custom plant variety) used in generating a garden plan. In yet another embodiment, a plant profile page for one or more plant varieties including information about the plant varieties including, but not limited to: planting characteristics; climate requirements; planting instructions; maintenance instructions; harvest instructions; size and weight; co-planting material; insects and diseases affecting the plant variety; and good and bad companion plant varieties for the plant variety is presented to the user.

For each plant variety selected in step S212, the user chooses a planting method from the list of suitable planting methods for the plant variety. If the planting nursery stock planting method is chosen, the user provides the estimated age of the nursery stock plant (e.g., based on a number of days). Also in step S212, the user chooses a desired number of servings per week, for each selected plant variety, during the harvest season. Servings are specifiable in whole quantities. A serving size (e.g., 1 cup) is a data element associated with each plant variety and is presented to the user for reference purposes.

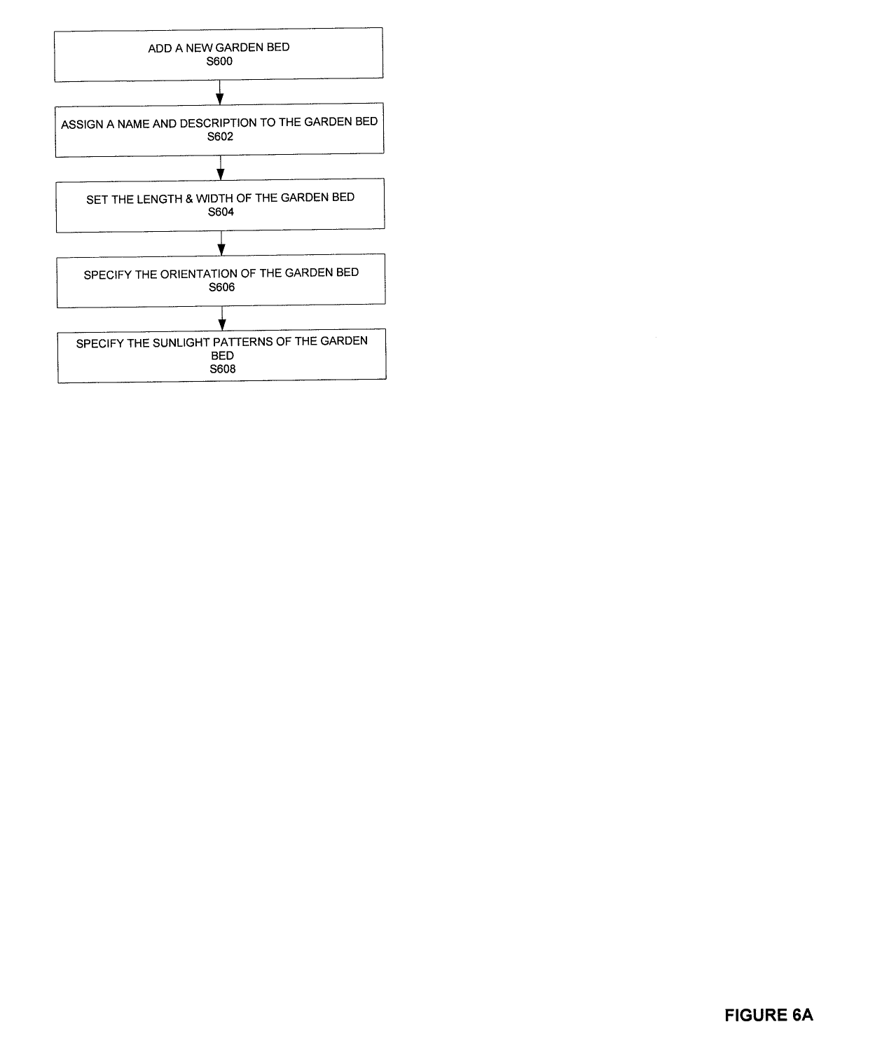

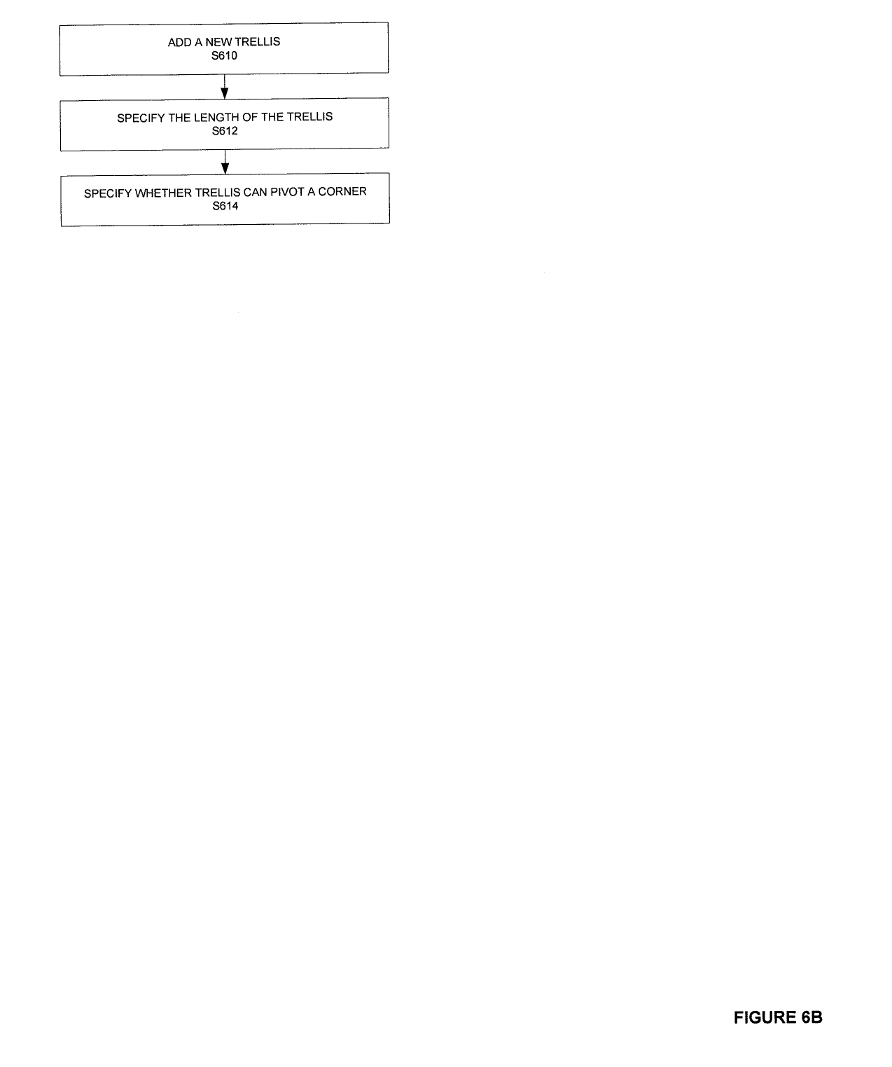

After selecting plant varieties, the process proceeds to step S214 in which garden hardware (e.g., garden beds and trellises) available to the user is specified and defined. In one embodiment, the user defines the garden hardware using the processes illustrated in FIGS. 6A and 6B. In another embodiment, the user skips the garden hardware definition process, causing the planning software to generate the garden plan and determining the garden hardware required in order to support the garden plan.

Referring now to FIG. 6A, the user adds a new garden bed to the garden plan, in step S600. In step S602, the user assigns a name and a description to the garden bed. The name and the description are used to identify the garden bed in the garden plan when presenting planting, maintenance, or harvest instructions to the user. In step S604, the user specifies the length and width of the garden bed and a visual representation of the garden bed is presented drawn to scale (where the length and width of the representation of the garden bed are presented in proportion to the length and width specified by the user). In step S606, the user specifies the orientation of the garden bed. In one embodiment, the user specifies orientation by selecting one of four directional arrows indicating which direction faces north. In another embodiment, the user specifies orientation by selecting one of four directional arrows indicating in which direction the sun rises. In yet another embodiment, the user specifies orientation by selecting one of four directional arrows indicating in which direction the sun sets. In step S608, the user specifies sunlight patterns affecting each square foot (e.g., a planting square) of the garden bed. In one embodiment, the user makes no changes to the sunlight patterns, causing each square foot to retain a sunlight pattern of full sun. In another embodiment, the user clicks on one or more square feet in the garden bed, causing the squares to be assigned a sunlight pattern of partial sun. In yet another embodiment, the user clicks twice on one or more square feet in the garden bed, causing the squares to be assigned a sunlight pattern of full shade.

Referring now to FIG. 6B, the user adds a new trellis, in step 610. In step S612, the user specifies the length of the trellis in linear feet. In step S614, the user specifies whether the trellis is pivotable about a corner. If the trellis is pivotable, then the planning software will assume that one half the length of the trellis can be placed on one side of the garden bed, while the other half can be placed on an adjacent side of the garden bed If the trellis cannot pivot a corner, then it is determined that the entire length of the trellis is used on one side of the garden bed.

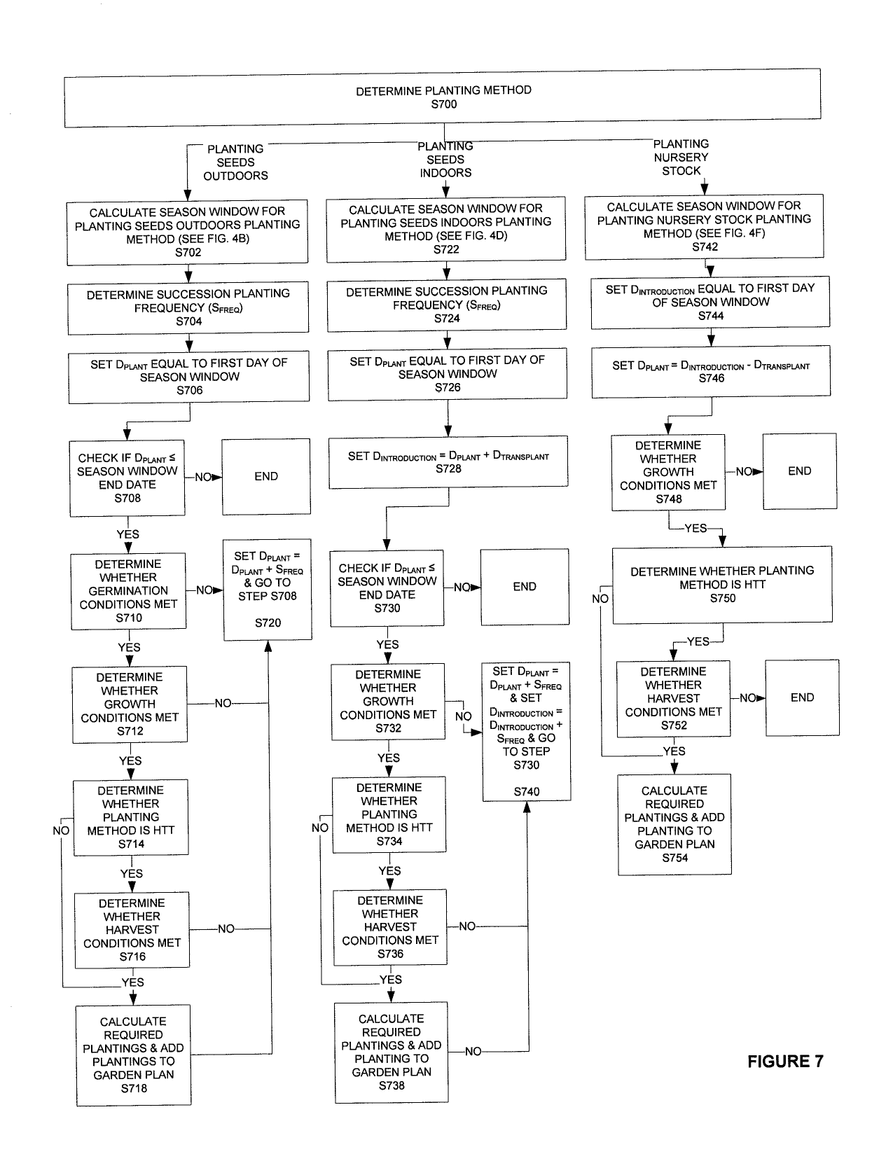

Referring back to FIG. 2, a garden plan that produces sufficient quantities of selected plant varieties to meet the user's desired quantities is generated in step S216. Details for generating the garden plan are presented in FIG. 7. Generating a garden plan requires calculating individual planting events, where a required number of seeds are planted using a specified planting method on a specified date. Each planting event is evaluated to ensure the germination, growth, and harvest conditions are met as required for the plant variety and harvest methods associated with the plant variety. If all conditions are met, the planting is added to the plan, and subsequent plantings of the same plant variety (i.e., succession plantings) are evaluated until the season window has expired. Calculating succession plantings (e.g., frequency and timing) ensure that the user will benefit from the longest possible harvest during the season window.

In step S700, the planning software determines the planting method chosen by the user for planting each plant variety selected for inclusion in the garden plan. If the planting method is planting seeds outdoors, then in step S702, the season window is calculated using the process described in FIG. 4B. Once the season window has been calculated, in step S704, the harvest method is checked, and a succession planting frequency is determined in accordance with Tables 2, 3, and 4. In step S706, the date the plant variety is to be planted (D_{PLANT}) is set to the first day of the season window. In step S708, D_{PLANT} is checked to ensure it falls before season end date—if not, the planting is determined to be invalid for the garden plan, and the process ends.

If the planting is determined to be valid, the process continues to step S710, at which it is determined whether germination conditions have been met by comparing the soil temperature requirements of the plant variety to the daily climate normal high air temperature during the germination period (D_{PLANT}+D_{GERM, HIGH}). The requirements are deemed to have been met if EQ. 1 is satisfied on at least one day during the germination period. If germination conditions have not been met, the planting is determined to be invalid for the garden plan, and in step S720, the next succession planting date is calculated by adding the succession planting frequency (S_{FREQ}) to the planting date (D_{PLANT}). The process then returns to step S708.

If the planting is determined to be valid for the garden plan, the process continues to step S712, at which it is determined whether growth conditions have been met by comparing the air temperature requirements of the plant variety to the daily climate normal high air temperature during the growth period (D_{PLANT}+D_{MATURITY, HIGH}). The requirements are deemed to have been met if a number of days (N) during the growth period in which EQ. 2 is satisfied also satisfies EQ. 3. If growth conditions have not been met, the planting is invalid, and in step S720, the next succession planting date is calculated by adding the succession planting frequency (S_{FREQ}) to the planting date (D_{DPLANT}). Then the process returns to step S708.

If the planting is determined to be valid for the garden plan in step S714, then the harvest method is checked. If the harvest method is harvest-till-temperature, then the process proceeds to step S716 at which it is determined whether harvest conditions have been met for the plant variety by comparing the harvest temperature requirements of the plant variety to the daily climate normal high air temperature on the first day of harvest (D_{PLANT}+D_{MATURITY, LOW}). The requirements are deemed to have been met if EQ. 2 is satisfied on the first day of the harvest. If harvest conditions have not been met, the planting is determined to be invalid for the garden plan, and in step S720, the next succession planting date is calculated by adding the succession planting frequency (S_{FREQ}) to the planting date (D_{PLANT}). Then the process returns to step S708.

If the planting is determined to be valid for the garden plan, or if the harvest method is not harvest-till-temperature, then the process continues to step S718, at which a required number of plantings is calculated, and the plantings are added to the garden plan. Required plantings are calculated as the requested servings per week (a gathered as user input during step S212 on FIG. 2) divided by the expected servings per week produced by the plant variety, and then increased by the loss adjustment percentage (LOSS %). The calculation of expected servings per week varies based on the harvest method of the plant variety and is presented in Tables 2, 3, and 4. The process continues to step S720, at which the next succession planting date is calculated by adding the succession planting frequency (S_{FREQ}) to the planting date (D_{PLANT}). Then the process then returns to step S708.

Referring back to step S700, if the planting method chosen by the user for the plant variety is planting seeds indoors, then the process is similar to the process for planting seeds outdoors, with some variation. In step S722, the season window is calculated using the process described with respect to FIG. 4D. Once the season window has been calculated, then in step S724, the harvest method is checked, and the succession planting frequency (S_{FREQ}) associated with the harvest method of the plant variety is obtained in accordance with Tables 2, 3, and 4. In step S726, the date the plant variety is to be planted (D_{PLANT}) is set to the first day of the season window. In step S728, the introduction date (D_{INTRODUCTION}), (i.e., the date the plant is to be transplanted outdoors) is calculated as plant date (D_{PLANT}) plus Days to Transplant (D_{TRANSPLANT}). In step S730, the plant date is checked to ensure it falls before a season end date—if it does not, the planting is determined to be invalid for the garden plan, and the process ends.

If the planting is determined to be valid with respect to the garden plan, the process continues to step S732, at which it is determined whether growth conditions have been met by comparing the air temperature requirements of the plant variety to the daily climate normal high air temperature during the outside growth period (D_{PLANT}+D_{MATURITY, HIGH}−D_{TRANSPLANT}). The requirements are deemed to have been met if the number of days (N) during the outside growth period that satisfy EQ. 2 also satisfies EQ. 3. If growth conditions have not been met, the planting is determined to be invalid for the garden plan, and in step S740, the next succession planting date (D_{PLANT}) and introduction date (D_{INTRODUCTION}) are calculated by adding the succession planting frequency (S_{FREQ}) to the planting date (D_{PLANT}) and introduction date (D_{INTRODUCTION}). Then the process returns to step S730.

If the planting is determined to be valid for the garden plan, in step S734, the harvest method is checked. If the harvest method is harvest-till-temperature (HTT), then the process proceeds to step S736, at which it is determined whether harvest conditions have been met for the plant variety by comparing the harvest temperature requirements of the plant variety to the daily climate normal high air temperature on the first day of harvest (D_{PLANT}+D_{MATURITY, LOW}). The requirements are deemed to have been met if EQ. 2 is satisfied on the first day of the harvest. If harvest conditions have not been met, the planting is determined to be invalid for the garden plan, and in step S740, the next succession planting date (D_{PLANT}) and introduction date (D_{INTRODUCTION}) are calculated by adding the succession planting frequency (S_{FREQ}) to the planting date (D_{PLANT}) and introduction date (D_{INTRODUCTION}). Then the process returns to step S730.

If the planting is determined to be valid for the garden plan, or if the harvest method is not harvest-till-temperature, then the process continues to step S738, where the required number of plantings is calculated, and the plantings are added to the garden plan. Required plantings are calculated as the requested servings per week (gathered as user input during step S212 on FIG. 2) divided by the expected servings per week produced by the plant variety, and then increased by the loss adjustment percentage (LOSS %). The calculation of expected servings per week varies based on the harvest method of the plant variety and is presented in Tables 2, 3 and 4. The process continues to step S740, where the next succession planting date (D_{PLANT}) and introduction date (D_{INTRODUCTION}) are calculated by adding the succession planting frequency (S_{FREQ}) to the planting date (D_{PLANT}) and introduction date (D_{INTRODUCTION}). Then the process returns to step S730.

Referring back to step S700, if the planting method chosen by the user for the plant variety is planting nursery stock, then the process is simplified with respect to the planting seeds outdoors planting method or the planting seeds indoors planting method. With the planting nursery stock planting method, succession plantings are not calculated; rather, the garden plan is limited to the original planting for a selected plant variety. In step S742, the season window is calculated using the process described in FIG. 4F. Once the season window has been calculated, in step S744, the date the plant variety is to be introduced to the outdoors (D_{INTRODUCTION}) is set to the first day of the season window. In step S746, the plant date (D_{PLANT}) is calculated according to EQ. 6.

The process continues to step S748, at which it is determined whether growth conditions have been met by comparing the air temperature requirements of the plant variety to the daily climate normal high air temperature during the outside growth period (D_{PLANT}+D_{MATURITY, HIGH}−D_{TRANSPLANT}). The requirements are deemed to have been met if a number of days (N) during the outside growth period in which EQ. 2 is satisfied also satisfies EQ. 3. If growth conditions have not been met, the planting is determined to be invalid for the garden plan, and the process ends.

If the planting is determined to be valid for the garden plan, in step S750, the harvest method is checked. If the harvest method is harvest-till-temperature, then the process proceeds to step S752 at which it is determined whether harvest conditions have been met for the plant variety by comparing the harvest temperature requirements of the plant variety to the daily climate normal high air temperature on the first day of harvest (D_{PLANT}+D_{MATURITY, LOW}). The requirements are deemed to have been met EQ. 2 is satisfied on the first day of harvest. If harvest conditions have not been met, the planting is determined to be invalid for the garden plan, and the process ends.

If the planting is determined to be valid for the garden plan, or if the harvest method is not harvest-till-temperature, the process continues to step S754, where the required number of plantings is calculated, and the plantings are added to the garden plan. Required plantings are calculated as a number of requested servings per week (gathered as user input during step S212 in FIG. 2) divided by the expected servings per week produced by the plant variety, and increased by the loss adjustment percentage (LOSS %). The calculation of expected servings per week varies based on the harvest method of the plant variety and shown in Tables 2, 3 and 4.

Subsequently, placement of each planting in an available location in a garden bed is determined (i.e., step S218 in FIG. 2). If the user did not define garden hardware in step S214 prior to generating the garden plan, then an insufficient number of garden beds exception is presented to the user, and the user is presented with an option to remediate the exception using the exception remediation process described in detail herein below. If the user did define garden hardware, then the plant placement process begins.

Planting locations are referenced by an address of a square foot section of a garden bed (e.g., a planting square). Addresses are assigned to each garden bed (e.g., at the time the garden bed is defined), referencing each vertical garden bed column using, for example, letters of the alphabet, starting with “A” and continuing from left to right until all columns have been assigned a letter. Each horizontal garden bed row is referenced using, for example, numbers, starting with “1” and continuing from top to bottom until all rows have been assigned a number. The combination of a column identifier (i.e., a letter) and a row identifier (i.e., a number) uniquely identifies each square foot planting location. For example, “A-1” represents a leftmost column and a topmost row in the garden bed as presented on a garden bed definition webpage. “A-2” represents the leftmost column, and the second row.

When assigning plantings to a planting square location, characteristics of a selected planting square are evaluated and compared to the requirements of the plant variety. If the characteristics of the planting square match the requirements of the plant variety, then the planting square is determined to be suitable for a planting of the plant variety. If the characteristics of the planting square do not match the requirements of the plant variety, then the planting square is determined to be unsuitable for a planting of the plant variety.

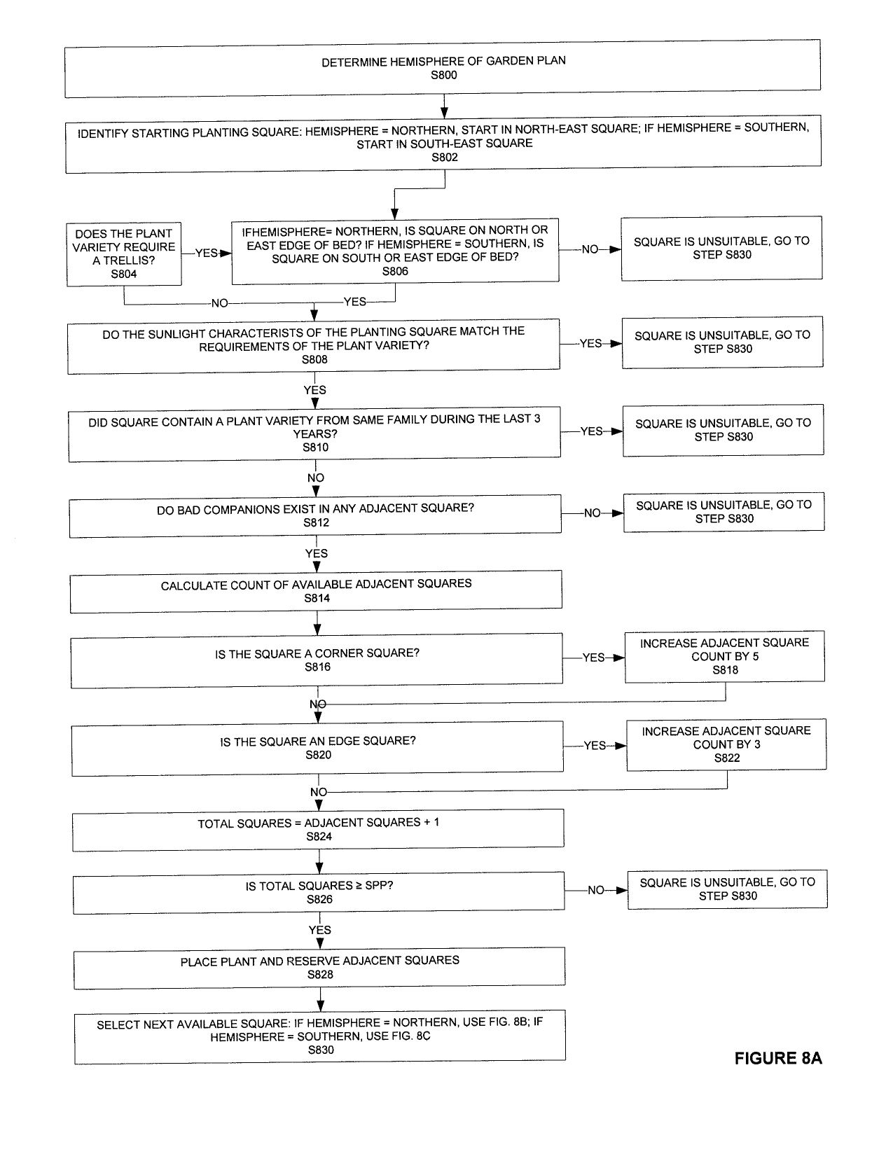

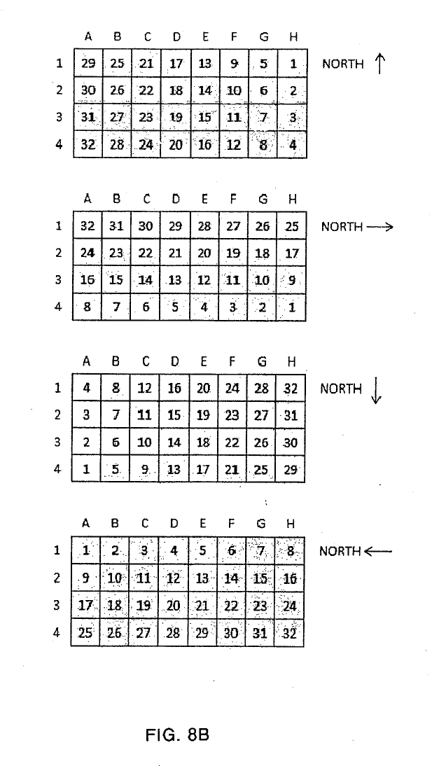

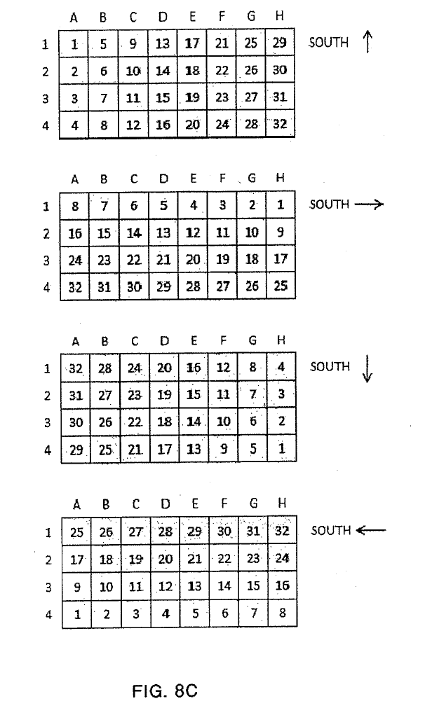

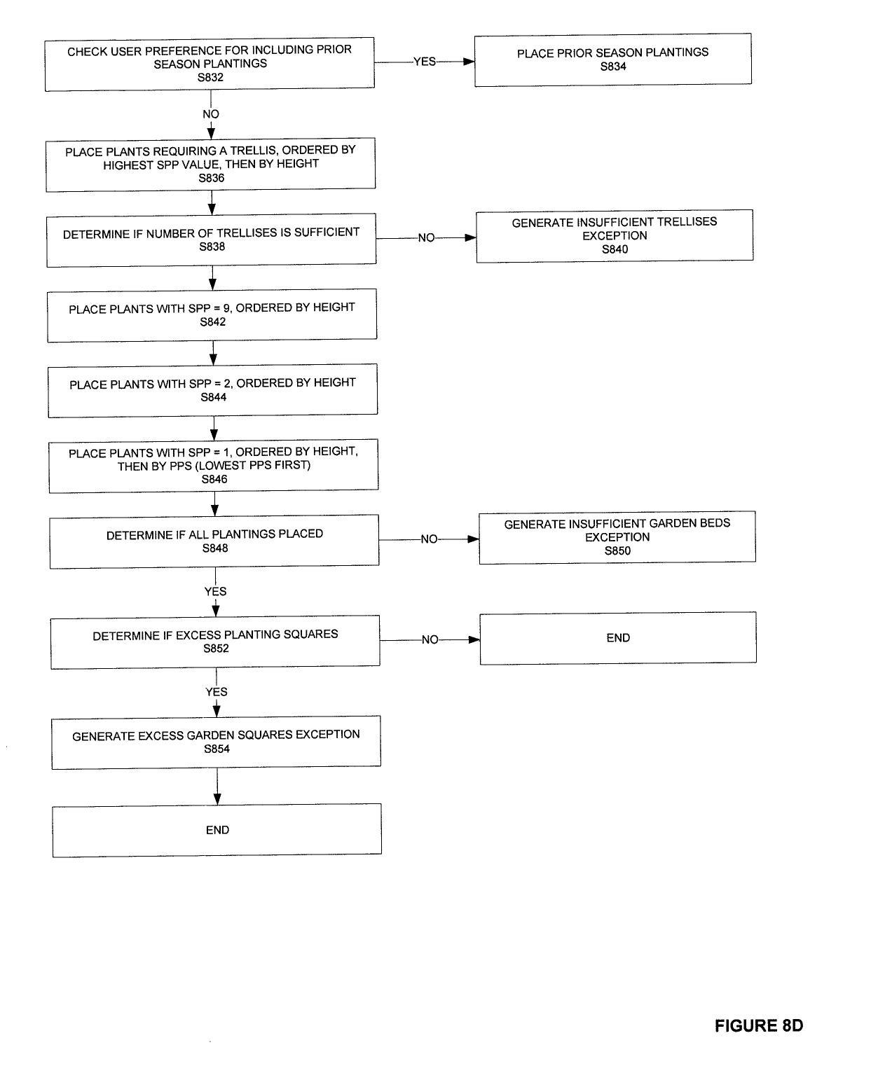

In FIG. 8A, a process flow diagram for evaluating planting square locations is shown. In step S800, a hemisphere in which the garden plan is to be implemented is determined. In step S802, a starting planting square is identified. If the garden plan is to be implemented in the northern hemisphere, then a planting square located in the northeast corner of the garden bed is selected as the starting square. If the garden plan is in the southern hemisphere, then a planting square located in the southeast corner of the garden bed is selected as the starting square.

In step S804, a determination is made as to whether the plant variety requires a trellis. In step S806, trellis requirements are checked to ensure that a planting square is suitable for a trellis. If the plant variety requires a trellis and the garden plan is to be implemented in the northern hemisphere, then the planting square must be located on the northern or eastern edge of the garden bed to be suitable for planting the plant variety. If the plant variety requires a trellis and the garden plan is to be implemented is in the southern hemisphere, then the planting square must be located on the southern or eastern edge of the garden bed to be suitable. If the planting square is not suitable, then the process continues to step S830. If the planting square is determined to be suitable, then the process continues to step S808.

In step S808, sunlight requirements for the plant variety are compared to the sunlight pattern assigned to the planting square in step S608 of FIG. 6A. If the sunlight requirement is full sun (SUN_{FS}) and the sunlight pattern assigned to the planting square is full sun, then the planting square is determined to be suitable for a planting of the plant variety. If the sunlight requirement is partial shade to full sun (SUN_{PSHADE, FS}) and the sunlight pattern assigned to the planting square is full sun or partial shade, then the planting square is determined to be suitable. If the sunlight requirement is shade (SUN_{SHADE}) and the sunlight pattern assigned to the planting square is full shade, then the planting square is determined to be suitable. If none of the above-noted three conditions are met, then the planting square is determined to be unsuitable and the process continues to step S830. If the planting square is determined to be suitable, then the process continues to step S810.

In step S810, a determination is made as to whether the planting square contained, in a predetermined number of preceding years (e.g., the preceding three years), a plant variety from the same plant family. If the determination in step S810 is positive, then the planting square is determined to be unsuitable for a planting of the plant variety and the process continues to step S830. Otherwise, the process continues to step S812.

In step S812, a determination is made as to whether any bad companion plant varieties have been planted in locations adjacent to the planting square being evaluated. Bad companions include plants that have a potential to adversely impact a plant variety being evaluated. If bad companion plant varieties exist in adjacent planting squares, the planting square is determined to be unsuitable for the plant variety and the process continues to step S830. If bad companion plant varieties do not exist in adjacent planting squares, then the process continues to step S814.

In step S814, a number of available planting squares adjacent to the planting square being evaluated is calculated. In order for a planting square to be available, no planting may exist in the planting square and the planting square must not be reserved for a planting during the entire germination, growth, and harvest phase of the plant variety being evaluated for placement in the planting square. In step S816, a determination is made as to whether the planting square is a corner planting square. If the planting square is a corner planting square, then in step S818, the number of available adjacent squares is increased by 5 to account for space outside of the garden bed. In step S820, a determination is made as to whether the planting square is an edge planting square (i.e., located along the edge of a garden bed, but not in the corner of the garden bed). If the planting square is an edge planting square, then in step S822, the number of available adjacent squares is increased by 3 to account for space outside the garden bed. In step S824, the total planting squares available for the planting is calculated as one more than a total number of available adjacent planting squares.

In step S826, a total number of planting squares available is compared to the squares per plant (SPP) value assigned to the plant variety. If total number of planting squares available is greater than or equal to the SPP value, then the planting square is determined to be suitable for the plant variety, and in step S828, the planting is placed in the planting square and the adjacent planting squares are marked as reserved. If the planting square is not suitable, then the process continues to step S830, where the next available planting square is selected following the order specified in FIG. 8B for garden plans located in the northern hemisphere, and following the order specified in FIG. 8C for garden plans located in the southern hemisphere. in FIGS. 8B and 8C, rectangles represent a typical garden bed, and each outlined square within the garden bed represents a single planting square. The letters and numbers outside the shaded squares represent a unique identifier for the planting square. The order in which planting squares are evaluated is specified by the number contained within each planting square, beginning with 1, and continuing in increments of 1 until all planting squares have been evaluated. If the user has specified more than one garden bed, then the planting squares in the first garden bed defined are evaluated first, followed by the planting squares in the second garden bed defined, and continuing until all garden beds have been evaluated.

The foregoing paragraphs describe an exemplary process by which a single planting is evaluated for placement within a planting square. The process by which plantings are selected for evaluation is included in the process flow diagram in FIG. 8D. In one embodiment, plant varieties that are more difficult to place are placed first, including those with requiring larger numbers of planting squares, or those containing restrictions on the planting square in which the planting may be placed. The process begins with step S832, in which the user's preference for considering prior season plantings is checked. This preference is a garden plan parameter obtained in step S200 on FIG. 2. If the user indicated a preference to consider prior season plantings, then in step S834, existing plantings from the prior season that extend into the current season (i.e., overflow plantings) are placed in the garden beds for the current season, causing such planting locations to be unavailable during the current season until harvest is complete for these prior season plantings. If the user did not indicate a preference to consider prior season plantings, then the process continues to step S836.

In step S836, plantings from the current season that require a trellis are attempted to be placed in an available location in the garden bed. When placing trellised plants, plant varieties with the highest squares per plant value (SPP) are selected first. Plants having a common SPP value are ordered by height (H_{MAX}), causing the tallest plants to be selected first. In step S838, a number of planting squares assigned to trellised plants is compared to a length of the trellises specified in step S612 is FIG. 6B. If the length of the specified trellises is less than the number of planting squares assigned to trellised plants, then an insufficient number of trellises exception is generated in step S840, and the user is presented with an option to remediate this exception using the exception remediation process described in detail herein below.

After placing trellised plants, the process continues in step S842 by placing plant varieties assigned a squares per plant (SPP) value of 9. Within this group of plant varieties, plants are ordered by height (H_{MAX}), causing the tallest plants to be selected first. The process continues to step S844 in which plants assigned a squares per plant (SPP) value of 2 are placed. Within this group of plants, plants are ordered by height (H_{MAX}), causing the tallest plants to be selected first. Lastly, plants assigned a squares per plant (SPP) value of 1 are selected for placement in step S846. Within this group, plants are ordered by height (H_{MAX}), causing the tallest plants to be selected first, then in descending order by plants per square (PPS), causing plants with the lowest plants per square value to be selected first.

In step S848, a determination is made as to whether all plantings were able to be placed. If not, then an insufficient number of garden beds exception is generated in step S850. If all plantings were able to be placed, then in step S852, a determination is made as to whether excess planting squares exist (i.e., planting squares that do not contain a single planting during the duration of the harvest season). If excess planting squares exist, an excess planting squares exception is generated in step S854. If either exception message was generated, then the user is presented with an option to remediate this exception using the exception remediation process described in detail hereinbelow.

Following generation of the garden plan and placement of the plantings, in cases where any of the above-noted exception messages were generated (e.g., insufficient number of garden beds, insufficient number of trellises, excess planting squares), remediation options are presented to the user in step S220 on FIG. 2. Remediation options for insufficient number of garden beds include, for example, purchasing additional garden beds from an entity implementing the planning software, reducing the number of weekly servings desired, or having the user supply their own garden beds. In one embodiment, the user chooses to purchase garden beds from an entity implementing the planning software or supply their own garden beds. In this case, the user defines the garden beds according to the process defined in FIG. 6A. Once this process is complete, the process for placing plants is repeated according to FIG. 8D. If additional exception messages are generated, the exception remediation process repeats until all exceptions are eliminated. In another embodiment, the user chooses to reduce the number of weekly servings desired for one or more plant varieties. After the user has finished reducing weekly servings desired, the garden plan is regenerated according to the process shown in FIG. 7, and the process for placing plants is repeated according to the process shown in FIG. 8D. If all plantings are able to be placed, a message is presented to the user informing the user that sufficient garden beds exist. If one or more plantings are unable to be placed, a message is presented to the user informing the user that insufficient garden beds exist. The user may continue to reduce desired weekly servings, or the user may choose to proceed with a different remediation option.

Remediation options for insufficient number of trellises include, for example, purchasing additional trellises from an entity implementing the planning software, reducing the number of servings desired, or having the user supply their own trellises. In one embodiment, the user chooses to purchase trellises from the entity. In such case, the user defines the trellises according to the process defined on FIG. 6B. Once this process is complete, the process for placing plants is repeated according to the process in FIG. 8D. If additional exception messages are generated, the exception remediation process repeats until all exceptions are addressed. In another embodiment, the user chooses to supply their own trellises. In such case, a trellis containing the required number of linear feet is added to the user's list of trellises. In yet another embodiment, the user chooses to reduce the number of weekly servings desired for one or more plant varieties. After the user has finished reducing weekly servings desired, the garden plan is regenerated according to the process shown in FIG. 7, and the process for placing plants is repeated according to the process shown in FIG. 8D. If all plantings are able to be placed, a message is presented to the user informing the user that sufficient trellises exist. If one or more plantings are unable to be placed, a message is presented to the user informing the user that insufficient trellises exist. The user may continue to reduce desired weekly servings, or the user may choose to proceed with a different remediation option.

Remediation options for excess planting squares include, for example, increasing desired weekly servings, or ignoring the exception and continuing to implement the garden plan as is. In one embodiment, the user chooses to ignore the exception and continue with the garden plan, causing the process to continue to step S222 in FIG. 2. In another embodiment, the user chooses to increase the number of weekly servings desired for one or more plant varieties. After the user has increased a desired number of weekly servings, the garden plan is re-generated according to FIG. 7, and the process for placing plants is repeated according to the process shown in FIG. 8D. If all plantings are able to be placed, a message is presented to the user informing the user that sufficient garden beds exist. If one or more plantings are unable to be placed, a message is presented to the user informing the user that insufficient garden beds exist. The user may choose to reduce a desired number of weekly servings for one or more plant variety, or the user may choose to proceed with a different remediation option.

After remediating exceptions, in step S222 on FIG. 2, a list of seeds required by the garden plan is presented to the user. In one embodiment, the user chooses to purchase one or more packages of seeds from the entity, causing the seed packages to be added to an online shopping cart for the user. In another embodiment, the user already has the required quantity of seeds and does not to purchase the seeds.

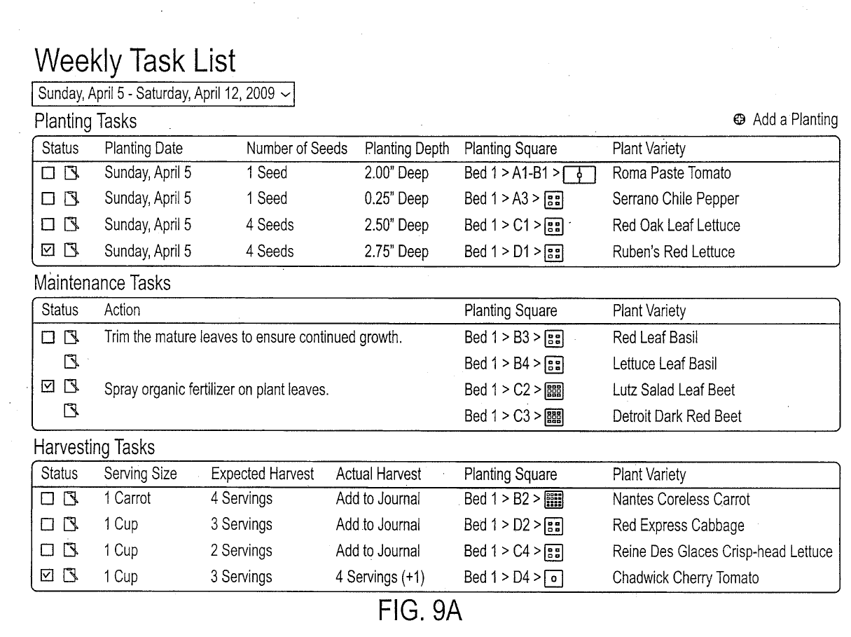

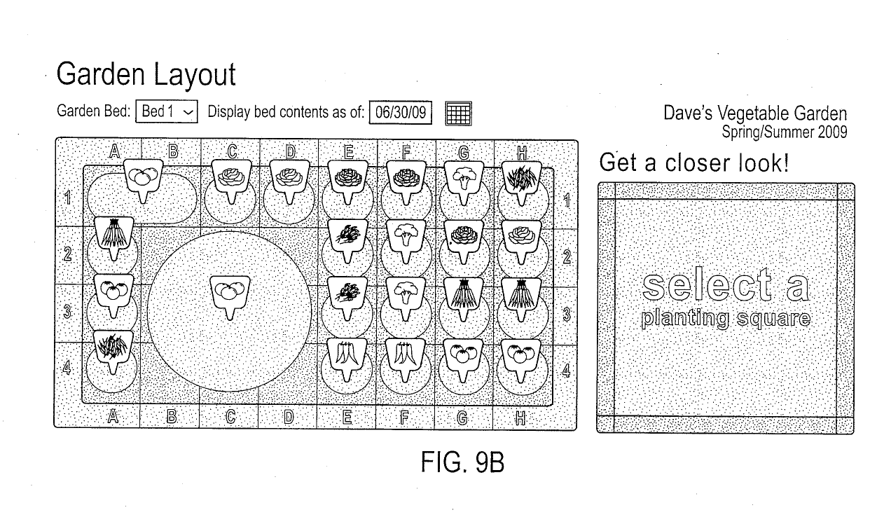

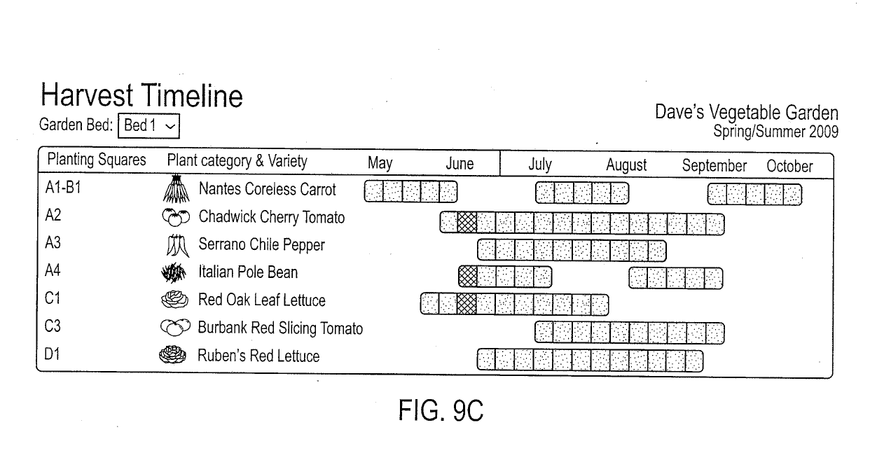

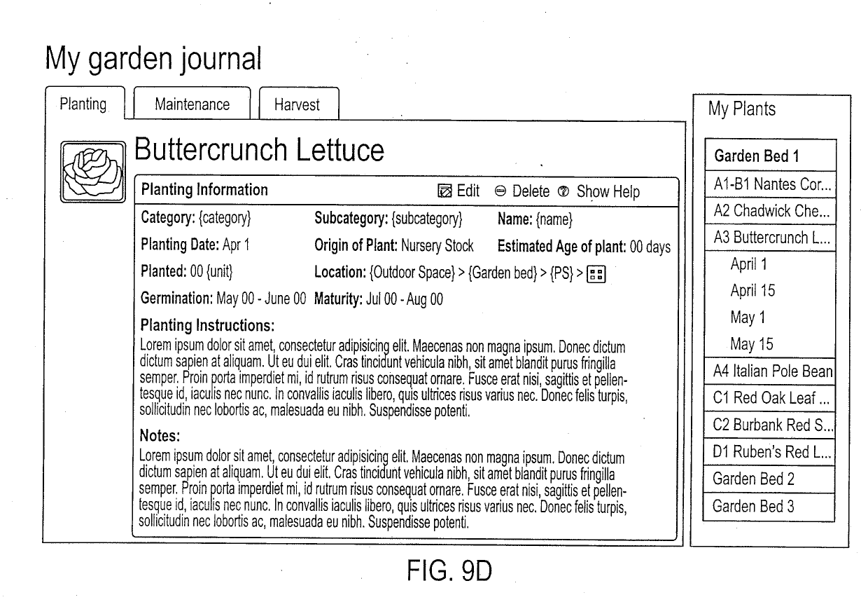

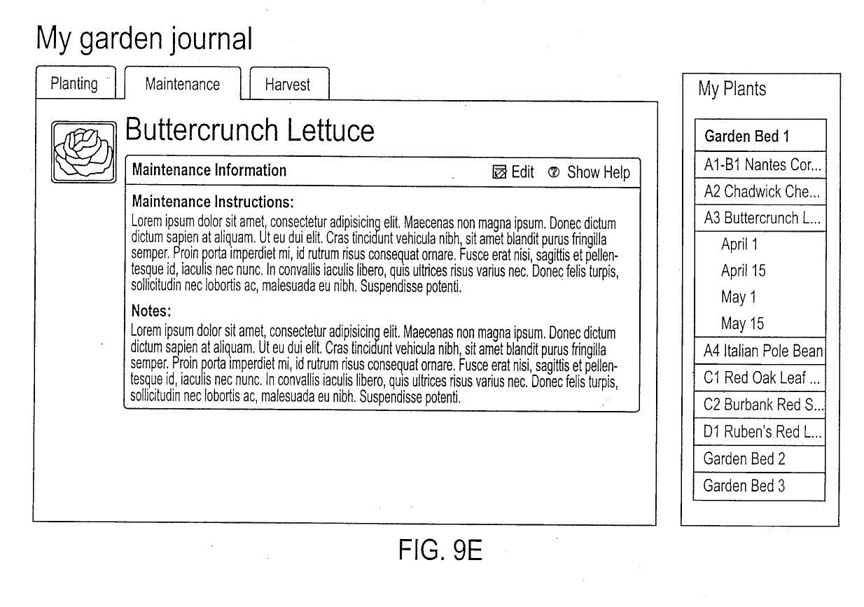

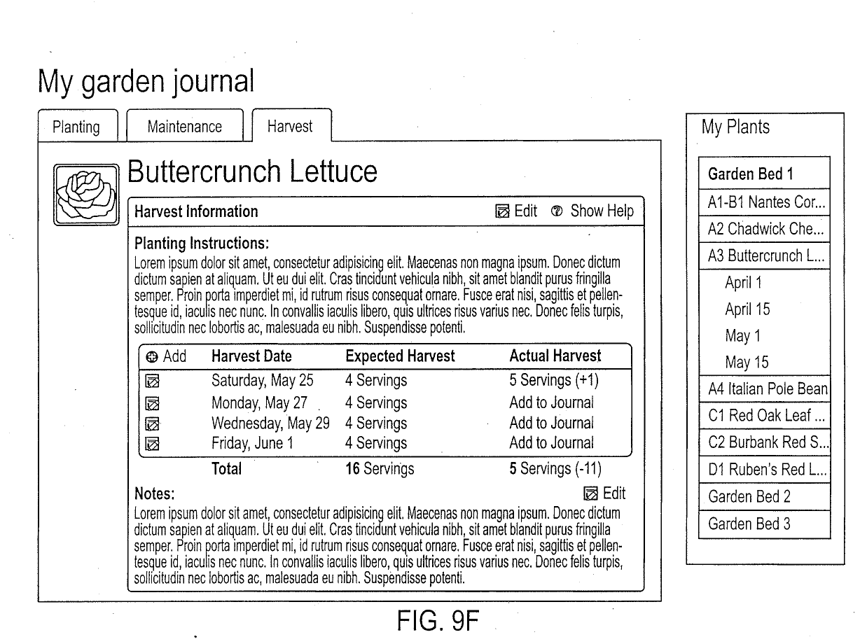

Referring to step S224 of FIG. 2, the garden plan is presented to the user. In one embodiment, a weekly task list view assists users to manage tasks associated with the garden plan for a selected week. In FIG. 9A, an exemplary weekly task list view of a garden plan is shown. The tasks presented as part of the task view are indicatable as being completed. In one embodiment, there are three categories of tasks: planting tasks, maintenance tasks, and harvesting tasks.

Planting tasks are triggered on the date that the planting occurs, including both planting seeds indoors, as well as planting seeds or nursery stock outdoors. Plantings for the selected week appear on the task view for the week. In one embodiment, when generating reminders to plant seeds, tasks are generated to use any co-planting material for the seed being planted.

Maintenance tasks are specific to each plant variety. Some plants have conditions which require monitoring in order to protect a harvest. For example, a user may have to pinch off the flowers from, for example, basil leaves in order to ensure that the plant continues to grow. In one embodiment, maintenance reminders appear on the weekly task list for every plant that is in a growth phase during a time period for which the task list is displayed. The growth phase is specified as any date which is greater than or equal to Days to Germination Low (D_{GERM, LOW}) and less than Days to Maturity Low (D_{MATURITY, LOW}).

Harvest tasks are presented on the weekly task list for every plant that is in the harvest phase during the period for which the task list is displayed. The harvest phase is specified as any date which is greater than or equal to Days to Maturity Low (D_{MATURITY, LOW}) and less than or equal to Days to Maturity High (D_{MATURITY, HIGH}). Harvest tasks provide the user with instructions for harvesting produce from the garden.

In another embodiment, the garden plan is presented in a garden layout view, which provides a graphical representation, as of a specified date, of a garden bed layout, along with an indication the plant variety planted in each planting square. In FIG. 9B, an exemplary garden layout view of a garden plan is shown. In yet another embodiment, the garden plan is presented as a harvest timeline. In FIG. 9C, an exemplary harvest timeline of a garden plan is shown. The harvest view is similar to a Gantt chart for a project plan and displays a row for each unique planting square and plant variety combination. Accordingly, the user is provided with a view of expected harvest dates. In another embodiment, the garden plan is presented as a garden journal, providing the user with detailed planting, maintenance, and harvest instructions for each planting included in the garden plan. FIG. 9D shows an exemplary view of the garden journal planting record; FIG. 9E shows an exemplary view of the garden journal maintenance record; and FIG. 9F shows an exemplary view of the garden journal harvest record.

In step S226 on FIG. 2, the user manages the garden plan and optionally makes changes to the garden plan including any of the following, but not limited to: changing the date of a planting; changing the date of a harvest; changing a plant variety of a planting; changing the location of a planting; eliminating a planting; adding a planting (e.g., if pests destroyed a plant); adding garden hardware; and eliminating garden hardware. If a user requested change causes a planting square evaluation criteria to be violated (e.g., planting bad companions next to each other), then the user is presented with a warning as to the priority rule being violated and is requested to confirm their selection before proceeding. When the user requests a change, the garden plan is recalculated for future plantings according to FIG. 7. Plantings placed prior to the date of recalculation are not updated. When garden plans exist for future seasons, and when changes are made to the current garden plan that cause the dates to change, then the garden plans for the future season are marked for recalculation when such plans include a user preference for including prior season plantings. In one embodiment, when the user opens the future garden plan, he or she is presented with a warning message indicating that the garden plan is no longer valid and must be recalculated. Recalculation causes future plantings to be revisited to ensure that planting dates are still appropriate as a result of the user requested change.

As set forth above, the system includes a vendor directory that facilitates purchase of high quality soil products in a user's local market, for example, compost, manure, straw, vermiculite, and peat moss. Manure, vermiculite and peat moss are typically available from garden centers. In one embodiment, the vendor directory also includes information regarding vendors that install garden bed hardware. In one embodiment, the vendor directory is searchable using a zip code, and the zip code defaults to a user's zip code. Search results of specified vendors in the vendor directory are displayable in a list format showing the distance from the user's home address and in one embodiment, include driving directions. In another embodiment, search results are displayable on a map. Specified products are searchable using a search engine-styled search, as well as searchable using a directory browsing method.

Contact details are provided for each vendor in the vendor directory in a vendor profile. Vendor profile information includes any of the following, but not limited to: business name, contact name, address, telephone number, email address, website address, hours of operation, general description and product profiles (including, for example, images and descriptions of products). Accordingly, a user is enabled to contact a vendor via email, telephone and postal mail. In one embodiment, user contact data (e.g., a number of times users have viewed contact information for a specified vendor) is recorded and archived to incentivize the vendor to purchase a subscription for inclusion in the vendor directory.

Although the disclosure has been described with reference to several exemplary embodiments, it is understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to means, materials and embodiments, the disclosure is not intended to be limited to the s disclosured; rather the disclosure extends to all functionally equivalent structures, methods, and uses such as are within the scope of the appended claims.

For example, although the description herein references multiple individual computers, local area networks and application servers, the descriptions herein would be applicable to subsequent or equivalent systems in which multiple or even all applications are provided by one or more application servers in a cloud environment provided by a third party. Similarly, the descriptions herein would be applicable to subsequent or equivalent systems in which individuals in an entity are distributed worldwide and each of the applications described herein is provided by one or more than one centralized application servers.

While a computer-readable medium herein may be shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosured herein.

In a non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present specification describes components and functions that may be implemented in embodiments with reference to standards and protocols, the disclosure is not limited to such standards and protocols. For example, standards for power over ethernet represent an example of the state of the art. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “disclosure” merely for convenience and without intending to voluntarily limit the scope of this application to any disclosure or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosured embodiments. Thus, the following claims are incorporated into the Detailed Description, with each claim standing on its own as defining separately claimed subject matter.

The above disclosured subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for generating a plan facilitating users to plant, grow, harvest and maintain selected plant varieties, comprising:
receiving, via at least one processor, user input corresponding to at least one of: the selected plant varieties, desired servings of the selected plant varieties, geographic information for the user and available gardening hardware;
determining, via the at least one processor, quantities of the selected plant varieties to plant, a location layout for planting each of the selected plant varieties and plant care tasks associated with each of the selected plant varieties; and
graphically presenting, via the at least one processor, the location layout and the plant care tasks associated with each of the selected plant varieties to the user.

2. The method according to claim 1,
wherein the geographic information comprises at least one of: a postal code, a latitude, a longitude and a mailing address.

3. The method according to claim 1, further comprising:
retrieving frost dates based on the geographic information.

4. The method according to claim 1,
wherein the quantities of the selected plant varieties account for an estimated loss percentage, and
wherein the estimated loss percentage is estimated based on weather, loss due to pests and loss due to plant disease.

5. The method according to claim 1, further comprising:
displaying a plurality of plant varieties to the user, from which the selected plant varieties are chosen, the plurality of plant varieties being chosen based on the geographic information and a current date.

6. The method according to claim 1, further comprising:
calculating a frequency for succession plantings over a current harvest period.

7. The method according to claim 1, further comprising:
obtaining information related to whether the user is willing to transplant plants from indoor to outdoor.

8. The method according to claim 1,
wherein the layout is based at least one of: a determination of which plant varieties to plant proximate to one another, a determination of which plant varieties to plant distant from one another, trellis requirements for each of the selected plant varieties, height of each of the selected plant varieties, water requirements for each of the selected plant varieties and sunlight requirements for each of the selected plant varieties.

9. The method according to claim 1, further comprising:
presenting the user with an option to purchase additional gardening hardware when gardening hardware requirements for producing the desired servings of the selected plant varieties exceed the available gardening hardware.

10. The method according to claim 6,
wherein dates for succession plantings and a frequency of succession plantings are based on a season window, and
wherein the season window is based on an earliest planting date, a latest maturity date and a calculated number of available growth days.

11. The method according to claim 1,
wherein the plant care tasks comprise at least one of: planting seeds outdoors, planting a plant from nursery stock, planting a plant grown from seeds sown indoors, harvesting plants, watering plants and pruning plants.

12. The method according to claim 1, further comprising:
displaying the plant care tasks according to dates on which the plant care tasks are to be performed.

13. The method according to claim 1,
wherein planting dates for planting the selected plant varieties are determined based on: frost hardiness, current harvest season and whether planting from seed, planting from nursery stock or planting from seeds sown indoors.

14. The method according to claim 1,
wherein the layout is based on a planting square division of a garden bed.

15. The method according to claim 14,
wherein a representation of a quantity of sunlight and a representation of a quantity of shade is displayed for each planting square of the garden bed.

16. The method according to claim 15,
wherein the user is enabled to at least one of: assign and edit the representation of the quantity of sunlight and the representation of the quantity of shade for each planting square of the garden bed.

17. The method according to claim 12, further comprising:
modifying the plan when one of the plant care tasks is not performed on a date on which the plant care task is to be performed.

18. The method according to claim 13,
wherein the planting dates are further based on air temperatures for at least one of: seed germination date and frost dates.

19. The method according to claim 1,
wherein a recommended garden bed size is presented to the user based on the desired servings of the selected plant varieties.

20. The method according to claim 1,
wherein plant seed catalogs from a plurality of vendors are supported.

21. The method according to claim 1,
wherein the user is enabled to purchase seeds for at least one of the selected plant varieties via a website interface.

22. The method according to claim 1,
wherein the user is enabled to manually enter a desired plant variety.

23. The method according to claim 1, further comprising:
archiving plans for at least one prior harvest season to determine whether crop cycling at a location is to be implemented.

24. A system for generating a plan facilitating users to plant, grow, harvest and maintain selected plant varieties, comprising:
a receiver that receives user input corresponding to at least one of: the selected plant varieties, desired servings of the selected plant varieties, geographic information for the user and available gardening hardware;
a determiner that determines quantities of the selected plant varieties to plant, a location layout for planting each of the selected plant varieties and plant care tasks associated with each of the selected plant varieties; and
a presenter that graphically presents the location layout and the plant care tasks associated with each of the selected plant varieties to the user.

25. A non-transitory, tangible computer readable medium for generating a plan facilitating users to plant, grow, harvest and maintain selected plant varieties, the medium comprising:
a receiving code segment, recorded on the tangible computer readable medium, that receives user input corresponding to at least one of: the selected plant varieties, desired servings of the selected plant varieties, geographic information for the user and available gardening hardware;
a determining code segment, recorded on the tangible computer readable medium, that determines quantities of the selected plant varieties to plant, a location layout for planting each of the selected plant varieties and plant care tasks associated with each of the selected plant varieties; and
a presenting code segment, recorded on the tangible computer readable medium, that graphically presents the location layout and the plant care tasks associated with each of the selected plant varieties to the user.

26. The non-transitory, tangible computer readable medium according to claim 25,
wherein a harvest season associated with the plan is defined by either a time period of increasing temperature that excludes short-term directional changes in temperature or a time period of decreasing temperature that excludes short-term directional changes in temperature.

27. The non-transitory, tangible computer readable medium according to claim 25,
wherein the user is enabled to manually edit a supported plant variety.

28. The non-transitory, tangible computer readable medium according to claim 24,
wherein the location layout is based on an orientation of a garden bed associated with the plan.

29. The non-transitory, tangible computer readable medium according to claim 28,
wherein the orientation of the garden bed is specified by the user based on at least one of:
graphically presented directional arrows and a geographic reference, and
wherein the geographic reference comprises at least one of: a north, south, east, west, sunrise and sunset direction.

30. The non-transitory, tangible computer readable medium according to claim 25,
wherein the presenting code segment further presents harvest instructions for each of the selected plant varieties.

31. The non-transitory, tangible computer readable medium according to claim 30,
wherein the harvest instructions are based on a harvest interval for each of the selected plant varieties.

32. The non-transitory, tangible computer readable medium according to claim 31,
wherein the harvest interval specifies a frequency of harvesting.

33. The non-transitory, tangible computer readable medium according to claim 28,
wherein the layout location for each of the selected plant varieties is specified based on at least one planting square in the garden bed.

34. The non-transitory, tangible computer readable medium according to claim 28,
wherein at least one planting square in the garden bed is evaluated to determine the location layout for each of the selected plant varieties.

35. The non-transitory, tangible computer readable medium according to claim 34,
wherein the at least one planting square is evaluated based on whether plants planted in the at least one planting square during a predetermined time period are members of a common taxonomy family with at least one of the selected plant varieties.

36. The non-transitory, tangible computer readable medium according to claim 34,
wherein the at least one planting square is evaluated based on crop rotation.

37. A method for generating a plan facilitating users to plant, grow, harvest and maintain selected plant varieties, the method comprising:
determining, by at least one processor, a level of suitability of a specified planting method for a specified plant variety based on at least one of: whether the specified plant variety is transplantable, whether a user is willing to plant seeds indoors for the specified plant variety and a season window for the specified planting method,
wherein the specified planting method comprises at least one of planting seeds indoors, planting nursery stock, planting seeds outdoors.

38. The method according to claim 37,
wherein the season window is a range of dates specifying a subset of a harvest season during which conditions are attained such that at least one plant of the specified plant variety grows.

39. The method according to claim 38,
wherein the season window is adjusted based on at least one of: germination temperature requirements for the specified plant variety, growth temperature requirements for the specified plant variety, frost conditions for a user location and sunlight conditions for the user location.

40. The method according to claim 38,
wherein the season window is adjusted further based on a suitability requirement defined by the user.

41. The method according to claim 40,
wherein the suitability requirement specifies at least one of: a time period in the season window and a percentage of the season window during which air temperatures are within a tolerable range for supporting plant growth for the specified plant variety.

42. The method according to claim 37, further comprising:
determining, by the at least one processor, whether a plant category associated with the specified plant variety is an onion category;
determining, by the at least one processor, whether a user location is located between a lower limit latitude and an upper limit latitude when the plant category is the onion category; and
determining, by the at least one processor, that the specified planting method is not suitable based on the user location.

43. The method according to claim 37,
wherein the level of suitability of the specified planting method is a binary determination.

44. The method according to claim 37,
wherein the level of suitability of the specified planting method is specifiable as one of at least three levels of suitability.
